(19) United States
(12) Patent Application Publication
(10) Pub. No.: US 2003/0229552 A1
(43) Pub. Date: Dec. 11, 2003

(54) System and method for deal-making decision optimization

(76) Inventors: Katarina J. Lebaric, Carmel, CA (US); Jovan Eugen Lebaric, Carmel, CA (US)

Correspondence Address: Michael L. Diaz, Michael L. Diaz, P.C., Suite 200, 555 Republic Drive, Plano, TX, 75074, US

(21) Appl. No.: 10/163,332

(22) Filed: Jun. 5, 2002

(51) Int. Cl. G06F 17/60

(52) U.S. Cl. 705/35

(57) ABSTRACT

A system and method for optimizing decision-making for deal-making transactions through a probability-based analysis of historical data. The system includes a computing system which performs a statistical and probability-based analysis on historical data for a specific type of transaction. The analysis may be utilized by the user to make informed decisions based on the analysis performed by the computing system.

### BACKGROUND OF THE INVENTION

1. Technical Field of the Invention

This invention relates to decision-making methodologies and, more particularly, to a system and method for optimizing decisions relating to situations where a deal or negotiation is involved, through statistical analysis.

2. Description of Related Art

For any situation where a deal is made, parties wish to maximize their gain. However, the desire for gain is balanced by the necessity of reaching an agreement, represented by the probability of the deal being made. Time is an additional consideration, as speed is often desired in a deal-making situation. Currently, the parties in a deal-making situation must work with relatively limited information resources. The resources may include the party's knowledge and experience, limited market data (typically from listings of data or basic averages), and the party's negotiating skills. These limited resources lead to a very intangible method of decision-making. A system and method are needed which provides a statistical basis and guide for decision-making.

Although there are no known prior art teachings of a solution to the aforementioned deficiency and shortcoming such as that disclosed herein, prior art references that discuss subject matter that bears some relation to matters discussed herein are U.S. Pat. No. 5,032,989 to Tornetta ('989), U.S. Pat. No. 4,870,576 to Tornetta ('576), U.S. Pat. No. 5,680,305 to Apgar, IV ('305), and U.S. Pat. No. 6,032,123 to ('123).

'989 discloses a search and location system for real estate, providing a user a selection of properties within their selected location, as well as information about the properties. However, '989 merely discloses a searching method utilizing criteria set by the operator. '989 does not teach or suggest decision-making based on statistical analysis.

'576 discloses a location system which incorporates the system disclosed in '989 with additional search qualifications, such as price, type of structure, and other information for searching within a database storing information on the properties. However, '576 only discloses searching available properties and does not teach or suggest analyzing past sold properties in combination with statistical and probabilistic methods to aid in the decision-making process.

'305 discloses a system and method of evaluating a business's current and prospective real estate situation and holdings, such as the price, grade, and degree of utilization of the business's holdings, and comparing these factors to those of similar business real estate holdings in the market, as well as indicating the current real estate situation for an area in which the business is located. An overall score representing a quantitative evaluation of the business's real estate condition is given (based on amount, price, grade, area and risk), including a report with analytical information. '305 discloses an analysis of the efficiency, value and risk involved in the ownership of real estate properties and may be used to determine if the purchase of a property is the proper decision. However, '305 does not teach or suggest a probabilistic assessment of the affordability (i.e., probability of being able to purchase at given prices) of the property or properties being considered as well as the expected timeframe for completing such a transaction. Additionally, '305 does not provide the ability to optimize the transaction itself in terms of key components, such as price, probability, and time.

'123 discloses a method of allocating, costing and pricing organizational resources. Specifically, '123 discloses allocating resources within an organization (e.g., moving resources from one department to another). '123 does not teach or suggest optimizing a user's finite resources (such as time and money) with respect to a current purchase or sale or presenting market-trend data. Additionally, '123 also utilizes a limited mathematical approach (with vector and matrix-driven improvement upon the linear programming model) rather than a probabilistic/statistical approach.

Additionally, there are existing products that are mathematical decision-support software tools for use by businesses and organizations, which are particularly used for supporting corporate managerial decision-making. One such existing product, Matrix Cognition™ utilizes an approach involving linear algebra of matrices and vectors. Matrix Cognition™ enters decision element evaluations pair-wise in a two-dimensional matrix, then solves the response matrix for its principal eigenvalue and for the eigenvector containing this principal eigenvalue. However, Matrix Cognition™ does not teach or suggest utilizing statistical analysis or a mathematical approximation of the histogram and probability density functions, as well as averaging.

Other additional products utilizing mathematic models for decision-making include products created by Palisade Corporation. The Palisade product provides cumbersome and complex software programs which provide non-industry specific decision-making analysis. Palisade® requires the user to enter data into a spreadsheet interface, without regard for the type of industry. Additionally, users of these products must determine which mathematical product is applicable to their business scenario, requiring user expertise and understanding of mathematic models. Palisade products merely provide a mathematical analysis based on inputs, often guesses, from the user. Palisade products do not teach or suggest a system or method focused on deal making which utilizes historical data.

Thus, it would be a distinct advantage to have a system and method which provides a statistical and probabilistic mathematical analysis of existing and past data for a specific industry to assist a user in decision-making. It is an object of the present invention to provide such a system and method.

### SUMMARY OF THE INVENTION

In one aspect, the present invention is a system for optimizing decision-making for deal-making transactions through a probability-based analysis of historical data. The system includes a computing system for analyzing data and an input terminal communicating with the computing system for inputting data on a transaction and selecting a type of analysis on the transaction data. The computing system receives historical data relevant to the analysis on the transaction. The computing system performs a probabilistic analysis on the historical data and presents the analysis to the user.

In another aspect, the present invention is a method of optimizing decision-making for deal-making transactions through a probability-based analysis of historical data. The method begins by a user providing a selection of desired analysis to be performed on a specified transaction to a computing system. The computing system then determines relevant historical data necessary for performing the selected analysis on the specified transaction. Next, the computing system obtains the relevant historical data and performs a probability-based analysis on the relevant historical data. The computing system then presents the analysis to the user. The analysis is used to assist the user in decision-making on the specified transaction.

In another aspect, the present invention is a method of optimizing decision-making for deal-making real estate transactions through a probability-based analysis of historical data. The method begins by a user providing a selection of desired analysis to be performed on a specified real estate transaction to a computing system. The computing system then determines relevant historical data necessary for performing the selected analysis on the specified real estate transaction. Next, the computing system obtains the relevant historical data and performs a probability-based analysis on the relevant historical data. The computing system then presents the analysis to the user. The analysis is used to assist the user in decision-making on the specified real estate transaction.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1A is an exemplary scatter plot for home sales;

FIG. 1B is a price difference histogram of FIG. 1A;

FIG. 1C illustrates days on market histogram of the home sales of FIG. 1A;

FIG. 2A illustrates a scatter plot for buyers in determining a probability of purchasing a property at a given price difference;

FIG. 2B is a scatter plotter and associated calculations for sellers in determining the probability of selling a property at a given price difference;

FIG. 3A illustrates a scatter plot and associated calculations for buyers in determining the probability of purchasing a property at a given price difference and determining the expected time to close a sale;

FIG. 3B is a scatter plot and associated calculations for a seller in determining the probability of selling a property at a given price difference and determining the expected time to close the sale;

FIG. 4A is a flow chart illustrating the steps for determining the price difference of buying a property a given probability;

FIG. 4B is a flow chart and associated calculations illustrating the steps for determining the price difference of selling a property a given probability;

FIG. 5A is a flow chart illustrating the steps for determining the price difference for a given probability of buying a property and determining the expected time to close;

FIG. 5B is a histogram of the days on market and is used in the method of FIG. 5A to determine the price difference and expected time to close a deal;

FIG. 5C is a flow chart illustrating the method of determining the price difference for a given probability of selling a property and determining the expected time to close a deal;

FIG. 5D illustrates a histogram of days on the market in an example of the methodology of FIG. 5C;

FIG. 6A illustrates a scatter plot and associated calculations for home sales and calculations for determining the probability of purchasing a property within a given time;

FIG. 6B illustrates a scatter plot and associated calculations for home sales and calculations for determining the probability of selling a property within a given time;

FIG. 7A illustrates a scatter plot and associated calculations for home sales and calculations for determining the probability of purchasing a property within a given time and determining the expected price difference for the purchase;

FIG. 7B illustrates a scatter plot and associated calculations for home sales and calculations for determining the probability of selling a property within a given time and determining the expected price difference;

FIG. 8A illustrates a scatter plot and associated calculations for home sales and calculations for determining the probability of purchasing a property within a given time and at a given price difference;

FIG. 8B illustrates a scatter plot and associated calculations for home sales and calculations for determining the probability of selling a property at a given price difference and within a given time period;

FIG. 9A illustrates a flow chart and calculations of determining the time to complete a purchase given the probability of buying a property;

FIG. 9B illustrates a flowchart and calculations of determining the time to complete a sale given the probability of selling a property;

FIG. 10A is a price difference histogram and calculations for determining the time to complete a purchase and the price difference expected value given the probability of buying a property;

FIG. 10B is a price difference histogram and calculations for determining the time to complete a purchase and the price difference expected value given the probability of buying a property;

FIG. 11 is a scatter plot and calculations for home sales for determining the estimated time for purchasing a property at a given price difference;

FIGS. 12A-12C illustrated graphs and calculations for determining time and price differences;

FIG. 13A illustrates a flow chart and calculations of determining the expected time to complete the purchase;

FIG. 13B illustrates a time to purchase histogram for FIG. 13A;

FIG. 13C illustrates a flow chart and calculations of determining the expected time to complete a sale;

FIG. 13D illustrates a time to purchase histogram for FIG. 13C;

FIG. 14 illustrates a profit histogram and calculations for determining the expected profit for a dual transaction scenario;

FIG. 15 illustrates the calculations necessary for determining the probability of a certain profit in a dual transaction scenario for a buyer and seller;

FIGS. 16A-J illustrates scenario graphs related to a dual transaction scenario functionality;

FIG. 17 illustrates a flow chart and calculations of determining the expected profit for a dual transaction scenario, under time constraints;

FIG. 18 is a flow chart and calculations of determining the probability of completing two transactions in a target timeframe for each transaction;

FIG. 19 illustrates a flow chart of determining the probability of a certain profit in a dual transaction scenario under time constraints;

FIG. 20 illustrates a flow chart of running a functionality from FIGS. 14-19 on a total dual transaction scenario;

FIG. 21 illustrates a price difference histogram and calculations for determining a price for time;

FIG. 22 is a flow chart illustrating the steps of determining which price range of properties provides the highest revenue;

FIG. 23 is a flow chart illustrating the steps of determining price, time, and probability characteristics of multiple for-sale properties;

FIG. 24A is a flow chart illustrating the steps of determining price for probability and time for a buyer;

FIG. 24B illustrates a flow chart illustrating the steps of determining a price for probability and time for a seller;

FIG. 25A is a block diagram illustrating the functionality for determining time for price and probability for a buyer;

FIG. 25B illustrates a block diagram for determining the time for price and probability of a seller;

FIG. 26 is a block diagram for determining the amenities that are most important in a property;

FIG. 27 is a block diagram illustrating the functionality for determining the effect, in terms of price and time, of changing the list price for a seller;

FIG. 28A illustrates a block diagram for determining a list price for target sales price for a seller;

FIG. 29 is a chart for determining list price for target sales price and time for a seller;

FIG. 30 is a block diagram illustrating the steps for comparing expected price and other key information for similar properties where one variable differs;

FIG. 31 is a block diagram illustrating the steps for determining expected value for a property;

FIG. 32 is a block diagram illustrating a functionality of maximizing expected value of a sale or maximize expected value per day for a sale within a target timeframe;

FIG. 33 is a block diagram for determining the expected value of a set of transactions;

FIG. 34 is a block diagram for maximizing revenue for a set of transactions or maximize revenue per day for a set of transactions;

FIG. 35 is a block diagram illustrating the functionality of increasing income to reach a target income;

FIG. 36 is a block diagram illustrating the steps for maximizing income by increasing the number of properties in the set or changing the mix;

FIG. 37A is a profit histogram utilized for determining current trends and market prediction;

FIG. 37B is a profit time series diagram utilized for determining current trends and market prediction;

FIG. 37C is a profit diagram of most recent data;

FIG. 37D is a diagram of most recent data shifted;

FIG. 37E is a graphical representation of computations;

FIG. 37F is a histogram of predictions for use in determining current trends and market prediction;

FIG. 37G is a diagram and associated calculations for most recent data and next day predictions;

FIG. 38 is a block diagram illustrating the functionality of evaluating a property as an investment;

FIG. 39 is a block diagram for evaluating relative probability of a pricing level;

FIG. 40 is a block diagram for averaging values;

FIG. 41 is a block diagram for linear interpolation of a histogram;

FIG. 42 is a block diagram for determining a standard deviation of any of the data values.

FIG. 42B is a profit histogram;

FIG. 42C is a price difference histogram;

FIG. 42D is a days on market histogram;

FIG. 43 is a block diagram for functionality variations relating to offers and profit;

FIG. 44 illustrates a block diagram for determining self-improvement of the process;

FIG. 45 is a simplified block diagram illustrating the components of a system 200 for optimization of deal-making decisions in the preferred embodiment of the present invention; and

FIG. 46 is a flow chart outlining the steps of optimizing deal-making decisions according to the teachings of the present invention.

### DETAILED DESCRIPTION OF EMBODIMENTS

The present invention system and method for deal making optimization through statistical and probabilistic analysis of historic and current data.

For each functionality involving timeframe, the user has the option to specify the target/resulting timeframe. For example, the timeframe may be specified as days on the market, days on escrow, or total transaction time (e.g., days on market plus day on escrow). However, although days are illustrated and discussed in the following figures, any time unit may be utilized, such as hours or years. Additionally, although the following figures refer to days on market, days on escrow, total timeframe, the operator has the ability to determine the type of time frame utilized for all functions using a timing variable.

For each functionality discussed below, a price difference may be inputted and outputted as a percentage. Alternately, actual price values may be utilized with the difference being implied by the price values. Price difference refers to the difference between the list price and sales price. List price difference refers to the change in list price, from original list price to current list, which may occasionally occur (e.g., seller changes list price of property). Thus, the functionalities involving price difference or price can be related to a list, offer, or sales price.

For all functionalities, the description may also specify whether the user is inputting the information as a buyer or a seller. However, buyers and sellers may use functionalities meant for the other transacting party for various reasons. Additionally, any person or business entity may utilized the presented invention, such as third party investors, agents, or other types of professional persons or business entities. The inputs provided to the computing system may be inputs not involving direct user input, such as from an automatic computer input.

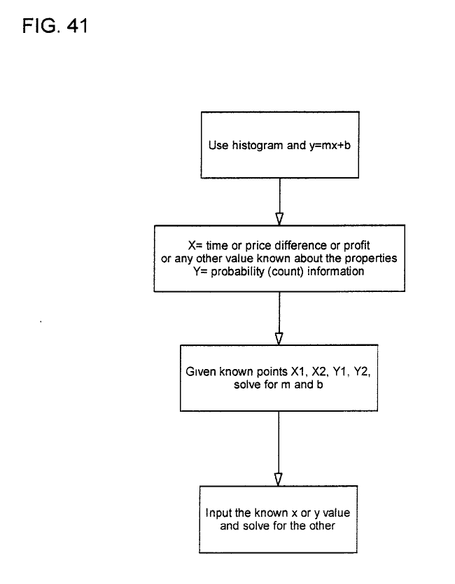

For all functionalities involving probability, all determinations using probability can use linear interpolation as discussed in FIG. 41. This can be used when the exact value of a probability or item of key information is not found in the existing data.

For the functionalities involving profit, the description and figures refer to profit. However, profit may also refer to breakeven or loss conditions, depending on the values. In addition, property/properties may include a property, service, or any right. Anything that may be bought or sold in a deal situation or where negotiations are involved may utilize the presented invention.

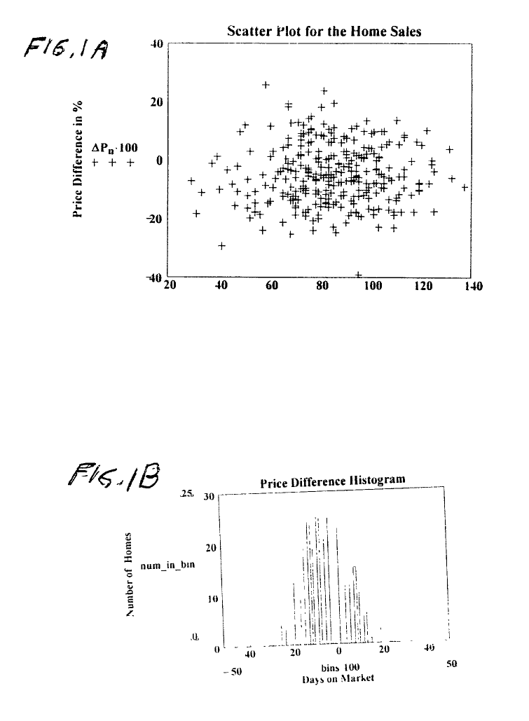

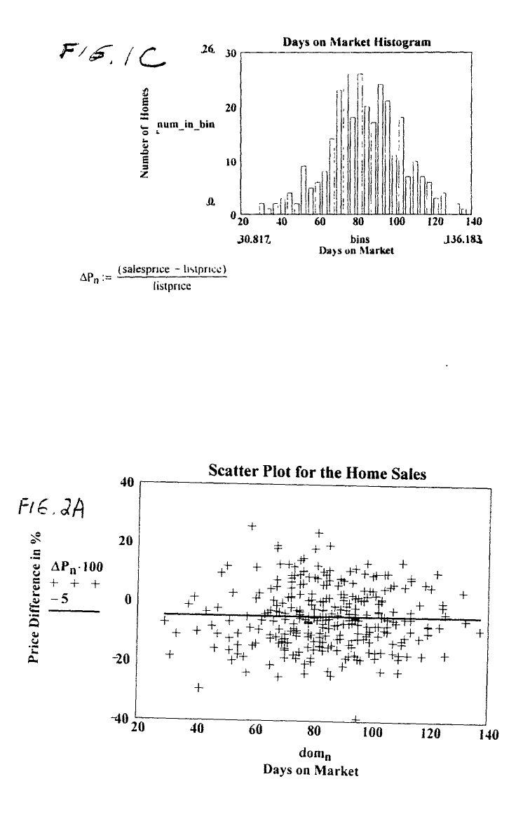

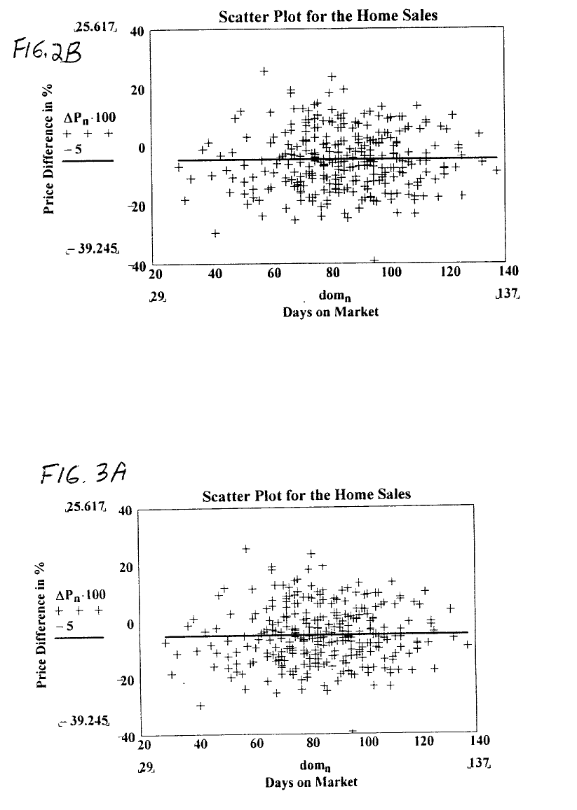

FIG. 1A is an exemplary scatter plot for property sales, using homes as an example. FIG. 1B is a price difference histogram of FIG. 1A. FIG. 1C illustrates a days on market histogram of the home sales of FIG. 1A. FIGS. 1A-1C show exemplary mathematical functions that are used in the disclosed invention. The actual numbers used in the FIGS. 1A-1C are from a random number generator and are provided as an example only. In FIG. 1B, a positive price difference means that a property sold above list while a negative price difference means it solved below the list. The mean value determines the seller's or the buyer's market. For example, a positive mean could illustrate a seller's market and a negative in a buyer's market. The standard deviation for the price difference indicates the price spread. The larger the standard deviation, the wider the range of price difference. A larger standard deviation indicates a wider range of price difference.

The timeframe (in days) is modeled as a Rayleigh distribution, since the time on market has to be strictly positive. The disclosed invention models the Rayleigh distribution as a distribution arising from two independent normally distributed random variables, each with the same mean value and the same standard deviation. The time and the price difference may be correlated. For example, if a property is discounted, the property may sell much faster. As illustrated, the correlation is not built in into the mathematical model in the disclosed invention. Thus, the time and the price difference are considered independent random variables.

Referring back to FIG. 1A, a scatter plot for properties in a given area is shown. The time is plotted on the horizontal axis and the price difference on the vertical axis. Given this information, the mathematical functionalities may be calculated as illustrated in FIGS. 1B and 1C.

The disclosed invention may utilize a computing system (discussed later) implementing software to perform the mathematic computations. The computing system receives an input data set or other input resulting from the output of the user's database queries. This can be done by direct input from the database, or by creating a log-file for telnet-based database access, or by saving the online database output in a data set of word processing or text type, or by other numerous methods in alternate embodiments. Alterations may be made for the input format, to make the computing system operable with the potentially different formats of the many database systems that exist nationwide, for web-based results pages, or for other considerations.

To enable the user of the data, the computing system parses the input file. In this process, the computing system extracts the key information, for example, the sales price, list price, days on market, sales data, close of escrow date and other relevant information of each sold property in the input file. If days on escrow is not provided, it may calculate days on escrow for each sold property by computing the days elapsed between the property's sales date and the close of escrow date.

The computing system may also calculate the change in price for each property, which is defined as sales price minus list price, divided by sales price. The computing system does the same for the change in list price, if applicable. This would be the current list price, minus the original list price, divided by the original list price. The computing system can then store the data for each property in a node, creating a structure of such nodes, which can be sorted by different characteristics.

In one embodiment of the invention once the end of the input data set is reached, the structure is completed. The computing system may then use the data in this structure, and derive additional information from it and to perform the requisite functionalities of the system.

FIG. 2A illustrates a scatter plot for buyers in determining a probability of purchasing a property at a given price difference. FIG. 2A illustrates the functionality where the buyer effectively inputs the maximum price he or she is willing to pay, by specifying the price difference. The buyer is then provided with the probability that a specific offer will be accepted. For this functionality, time is not a factor. To determine the probability, the number of properties at or below the given price difference is counted and the count divided by the total number of properties.

FIG. 2A illustrates the operation of this functionality with an example. In the example, an assumption is made that the buyer is willing to pay at most 95% of the list price; thus, the price difference of −5% is illustrated (5% below the list price). The probability the user is looking for is equal to the number of properties (represented as crosses in FIG. 2A) at or below the −5% line divided by the total number of properties, because all the crosses represent properties sold at or below the 95% of the list price (i.e., the buyer does not mind paying less but does not want to pay more than 95% of the list price). Mathematically, this represents the cumulative distribution function (cdf), which is the integral of the probability density function (pdf). In this implementation, the integration is replaced by the summation, or counting as described above.

FIG. 2B is a scatter plotter and associated calculations for sellers in determining the probability of selling a property at a given price difference. The functionality illustrated in FIG. 2B shows how the seller effectively inputs the minimum price he or she is willing to receive, by specifying the price difference. The seller may desire to know the probability that a specific offer will be accepted. The time is not a factor in this function. In order to determine the probability, the number of properties at or above the given price difference is counted and the count divided by the total number of properties.

FIG. 2B illustrates the operation of this functionality with an example. In the example provided, it is assumed that the seller will accept an offer at or above at least 95% of the list price. This specifies the price difference of −5% (5% below the list price). The line at −5% is depicted in FIG. 2B. The probability the user is looking for is equal to the number of properties (represented as crosses in FIG. 2B) at or above the −5% line, divided by the total number of properties. All the crosses represent properties sold at or above the 95% of the list price (indicating that the seller does not mind receiving more, but will not accept less than 95% of the list). Mathematically, this is the definition of the cumulative distribution function (cdf), which is the integral of the probability density function (pdf). In the preferred embodiment, the integration is replaced by the summation, or “counting” as described above.

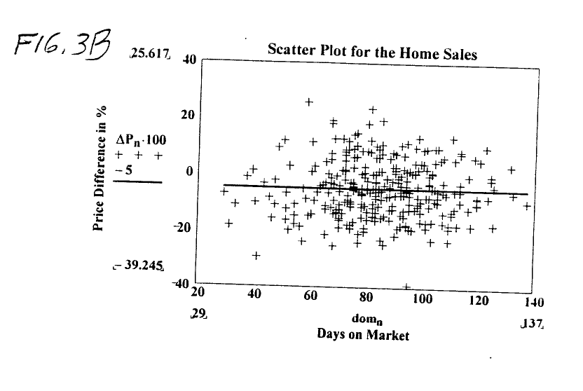

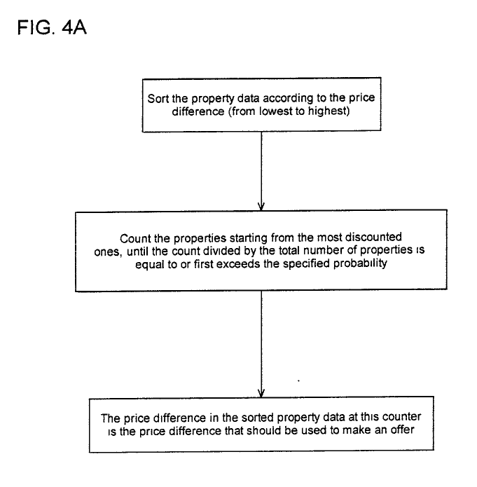

FIG. 3A illustrates a scatter plot and associated calculations for buyers in determining the probability of purchasing a property at a given price difference and determining the expected time to close a sale. The buyer effectively inputs the maximum price he or she is willing to pay, by specifying the price difference. The buyer may then desire to know the probability that the offer will be accepted. A probability is calculated that the buyer will purchase the property at or below his or her offer, as explained in FIG. 2A. In addition, the buyer may want to know the expected time to close the transaction (assuming that the offer would be successful). The expected time can be requested in terms of days on market, days on escrow, or total purchasing time, and thus closing the transaction may refer to an offer acceptance or a fully completed purchase. To calculate this expected time, the buyer needs to know the time elapsed for the particular property (e.g., the number of days it has been on market, and/or on escrow) and the expected (average) time for the properties that sold at or below the specified price difference.

In calculating the expected time, the time values are averaged for the properties that sold for price differences at or below the user-specified price difference. The number of days that the property has been on market is subtracted thus far from the average days on market value, providing the expected time.

In FIG. 3A, an example is provided where the user specifies a price difference of −5%, and that the number of days the property has been on market thus far is 40. The number of properties below the horizontal line (which represents the price difference of −5%) is counted and the average days on market is determined for those properties. In the example for FIG. 3A, the average days on the market is 84. The number of days the property has been on the market thus far (40) is subtracted from 84, to give an expected time to close the sale of 44 days. The probability of 52.3% was found in FIG. 3A.

FIG. 3B is a scatter plot and associated calculations for a seller in determining the probability of selling a property at a given price difference and determining the expected time to close the sale. The seller effectively inputs the minimum price that he or she is willing to accept, by specifying the price difference. A probability is calculated that the seller will sell the property at or above the inputted price difference, as shown in the functionality of FIG. 2B.

In addition, the seller may want to know the expected time to close the transaction (assuming that the sale would be successful). In calculating the expected time (which can be in terms of days on market, days on escrow, or total purchasing time), the time values for the properties that sold for price differences at or above the user-specified price difference are averages which are termed the expected time.

In FIG. 3B, as an example, the user specifies a price difference of −5%. The number of properties above the horizontal line is counted, which represents the price difference of −5%. It is also determined the average days on market for those properties. In the example provided, the average days on market value is 85. The probability for the example illustrated in FIG. 3B is 47.7%.

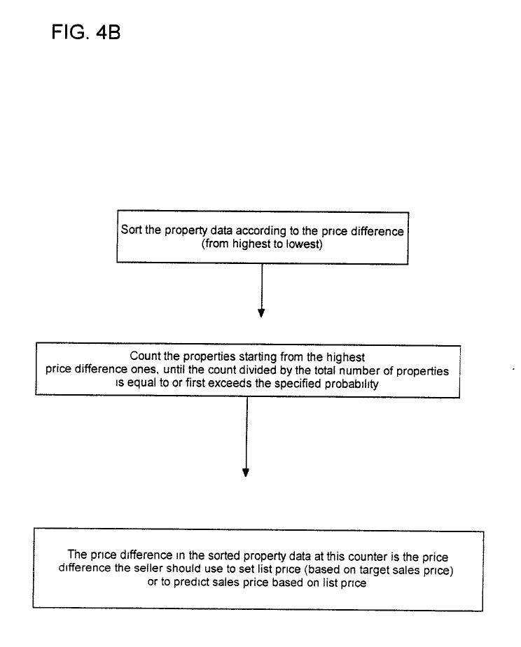

FIG. 4A is a flow chart illustrating the steps for determining the price difference of buying a property a given probability. The buyer inputs the desired probability that he or she will be successful at purchasing a property. The price difference for the specified probability is calculating, thus allowing the buyer to use this price difference to make an offer.

To provide this price difference, the method starts with sorting the property data according to the price difference (from lowest to highest). Next, the properties are counted, starting from those with the lowest price difference values, until the count divided by the total number of properties is equal to or first exceeds the specified probability. The method utilizes the price difference of the property that the counter is at as the price difference. The determined price difference for the desired probability may be used for a buyer in making an offer for the property.

As illustrated as an example in FIG. 3B, the user specifies a target probability of 65%. The price difference is thus calculated at −1.396%. Thus, the buyer should offer to pay 1.396% less than the list price to have the 65% probability of his or her offer being accepted.

FIG. 4B is a flow chart and associated calculations illustrating the steps of determining the price difference of selling a property a given probability. The seller inputs the probability that he or she will be successful at selling the property. The method calculates the price difference for the specified probability. Depending on which option the seller selects (determining the list price or determining the sales price)the seller has two options. First, the seller may determine the list price for the property at that probability. In one embodiment, this may be done by multiplying the selling price he or she wants by the factor of n, where n is 1 minus the calculated price difference. Second, the seller may use this method to determine the sales price for the property at that probability, by accumulating the expected price difference onto the list price.

To provide this price difference, the method starts by sorting the property data according to the price difference (from highest to lowest). Next, the properties are counted, starting from those with the highest price difference values, until the count divided by the total number of properties is equal to or first exceeds the specified probability. The functionality will then return the price difference of the property that the counter is at as the price difference. FIG. 4B illustrates an example where the probability enter is 65%. A price change value of −9.716 is calculated. The list price value is found to be −0.115, using the formula shown utilized in FIG. 4B. This means that the seller should add 11.5% to the price he or she wants to sell at to arrive at the list price. The seller can then lower the list price by 9.716% (of the list price) and sell the property at his or her target sales price, with the 65% probability of this actually happening. It can also mean that the seller should expect to sell for 9.716% less than the list price, at that probability.

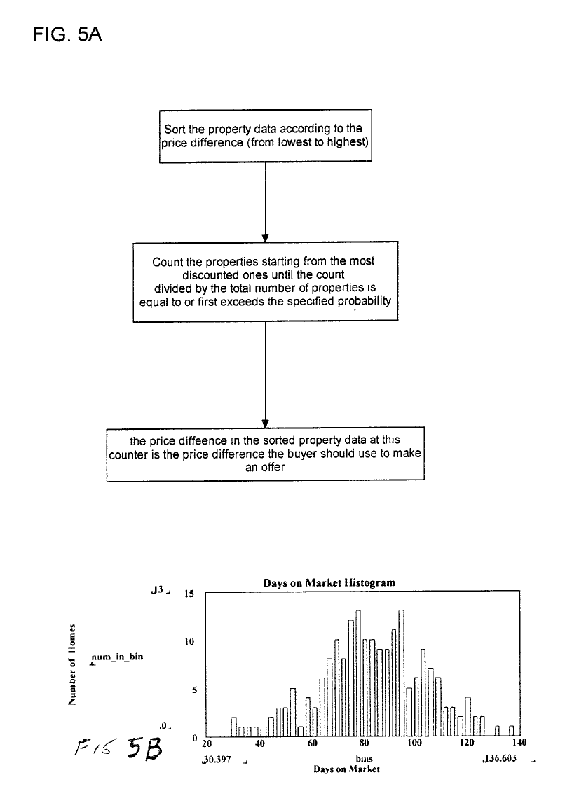

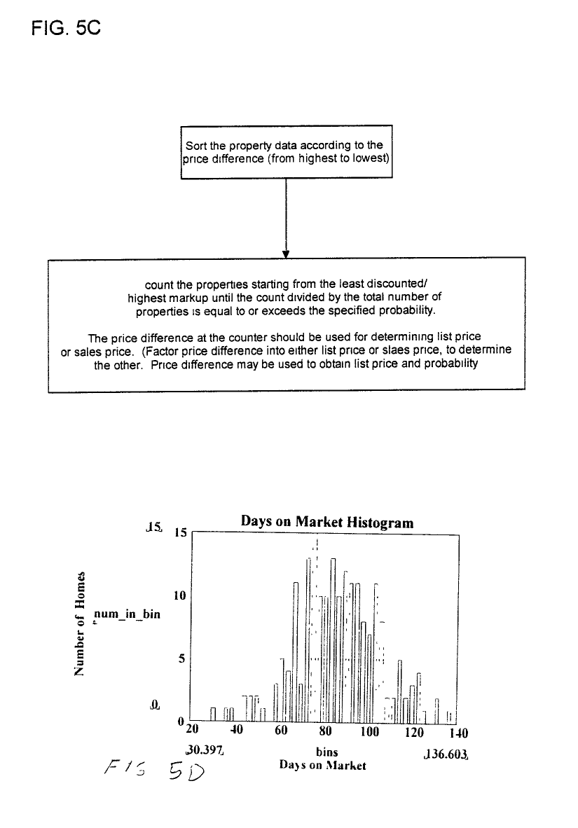

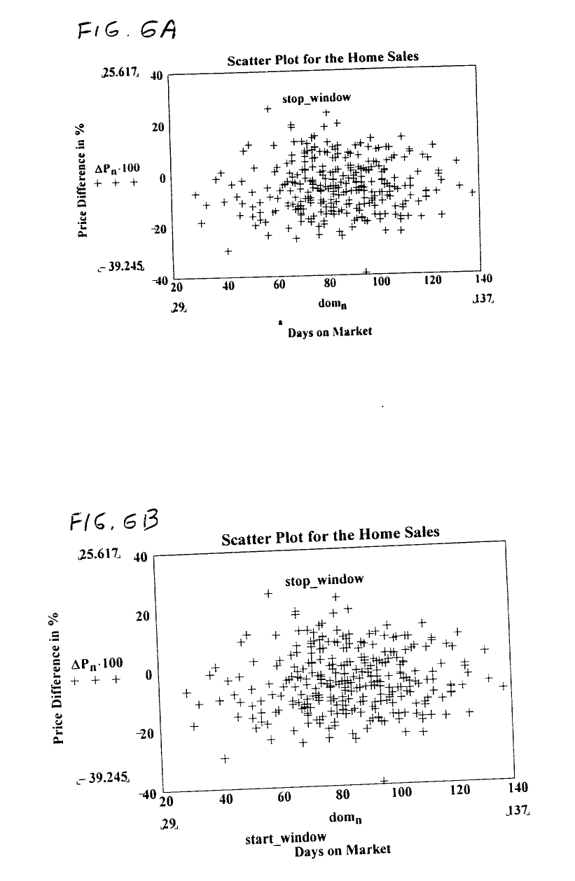

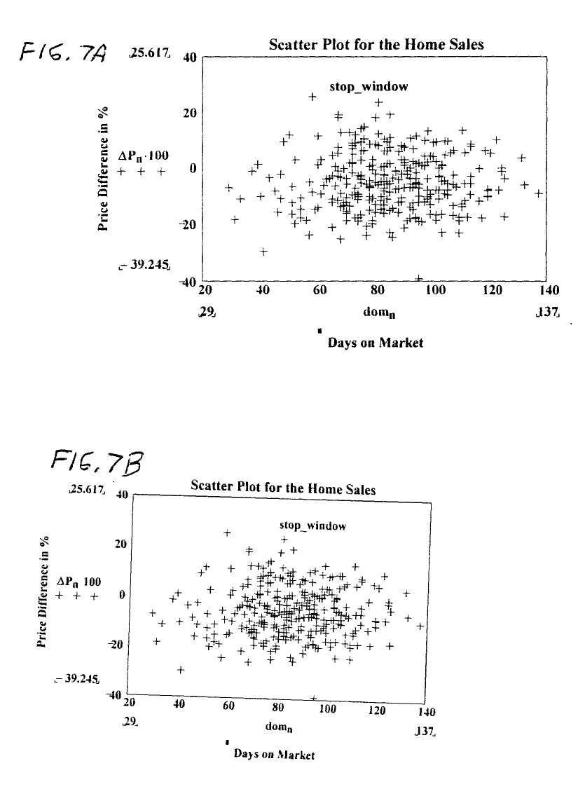

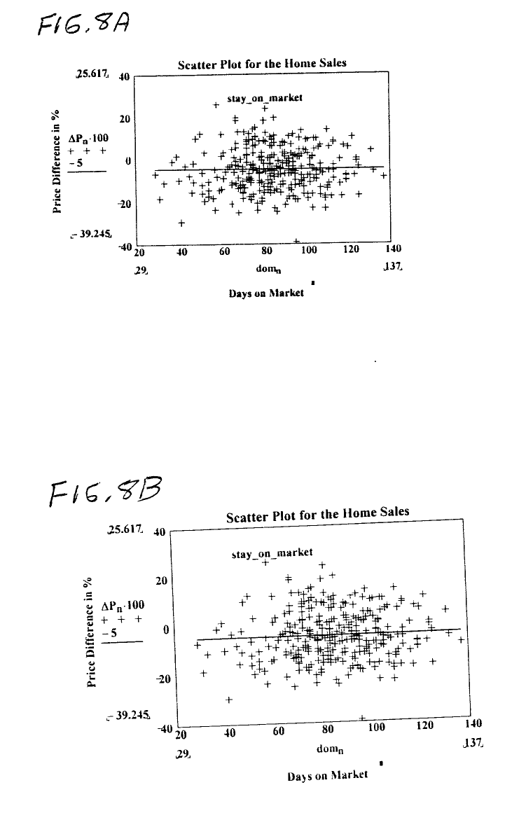

FIG. 5A is a flow chart illustrating the steps for determining the price difference for a given probability of buying a property and determining the expected time to close. The buyer inputs the probability that he or she will be successful at purchasing a property. The method calculates the price difference for the specified probability. The buyer then uses this price difference to make an offer. The buyer will also receive the expected time (in terms of days on market, days on escrow, or total purchasing time) for closing the deal. To provide the price difference, the method begins by sorting the property data according to the price difference, from lowest to highest. Next, the properties are counted, starting from the most discounted properties, until the count divided by the total number of properties is equal to or first exceeds the specified probability. The price difference for the property at this counter value is the price difference utilized by the buyer to make an offer. To determine the expected time, the method will determine the mean and standard deviation of the timeframe values for the properties that were counted. The mean (less than number of days of time that the property has accumulated thus far) will be the expected time, and the standard deviation will also be presented. FIG. 5A utilizes the example of 65% as the probability.

FIG. 5B is a histogram of the days on market and is used in the method of FIG. 5A to determine the price difference and expected time to close a deal. In the manner described above, the method determines that the price difference is −1.396%. This means that the buyer should offer to pay 1.396% below the list price to have a 65% probability of his or her offer being accepted. In the example, the number of properties counted to arrive to the result is 197. The days on market for these properties is summed and divided by 197, to determine a mean of 84 days on market. The property has been on the market for 40 days thus far, so the expected time is 44 additional days. The standard deviation is found to be 19 days.

FIG. 5C is a flow chart illustrating the method of determining the price difference for a given probability of selling a property and determining the expected time to close a deal. The seller inputs the probability that he or she will be successful at selling the property. The method calculates the price difference for the specified probability. The seller can then use this price difference to set the list price (given the seller's target sales price), or to determine the sales price for that probability (given the list price), depending on the functionality selected. The seller will also receive the expected time (which can be in terms of days on market, days on escrow, or total purchasing time) for closing the deal. To provide the price difference, the method starts with sorting the property data according to price difference (from highest to lowest). Next, the properties are counted, starting from the most discounted properties, until the count divided by the total number of properties is equal to or first exceeds the specified probability. Next, the price difference that was calculated is utilized by the seller to determine the list price or sales price (depending on the functionality selected). To determine the expected time, the method determines the mean and standard deviation of the timeframe values for the properties that were counted. The mean (less the number of days of time that the property has accumulated thus far) will be the expected time, and the standard deviation will also be presented.

FIG. 5D illustrates a histogram of days on the market in an example of the methodology of FIG. 5C. In the example provided, the user enters 65% as the probability. In the manner described above, the method determines that the price difference is −9.716%. This is used to determine how to set the list price for the property he or she is selling, so that the probability of receiving the target sales price for the above list price is 65%. FIG. 5D uses the list price factor equation to determine a factor of 1.108. This means the list price should be set at 1.108 times the selling price, indicating that a seller that desires a 65% probability of selling a property (for this particular market segment) should increase the target sales price by 11.8%. Alternately, this can also mean that the seller can expect their sales price to be 9.716% less than their list price.

The mean time value is determined to be 87, which is the expected time to sell the property. The standard deviation is 20 days. Note that the histogram illustrated in FIG. 5D provides more information, such as that the longest time on market is around 130 days and the shortest time on market is around 35 days.

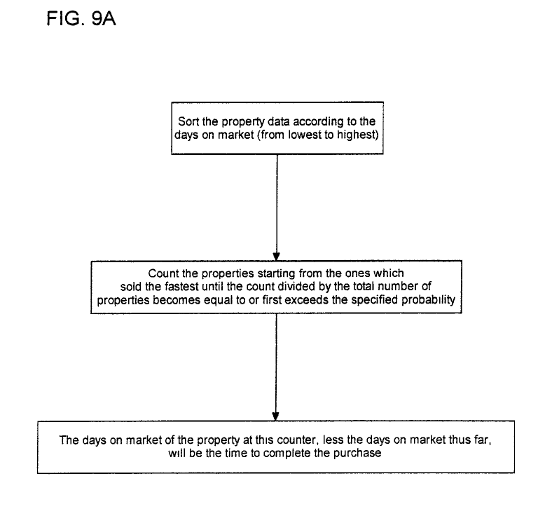

FIG. 6A illustrates a scatter plot and associated calculations for home sales and calculations for determining the probability of purchasing a property within a given time. The buyer inputs the time (in terms of days on market, days on escrow, or total purchasing time) within he or she would like to complete a transaction. The completion may be defined as an offer acceptance, or a fully completed purchase. The price is not a factor in this function. This implies that the buyer will be reasonably interested in purchasing the property, and that his or her offers will reflect that. A buyer could potentially present such low offers that he or she will never complete the purchase. Therefore this functionality does not guarantee a purchase, but rather provides the probability of purchase within a given time, pending reasonable offers.

The buyer has to input the days accumulated thus far for the property that he or she is interested in, and the timeframe within which the buyer would like to achieve the transaction (which may mean an offer acceptance, or fully completed purchase). The method will add the number of days the property has accumulated thus far to the timeframe within which the buyer would like to complete the purchase. The method counts the number of properties that were transacted within a number of days that is less than or equal to this sum. This count is then divided by the total number of properties, which gives the probability or purchasing the property within the specified timeframe.

The example illustrated in FIG. 6A illustrates this with an example. In the example provided, the property has been on market for 45 days, and the user would to purchase the property within 30 days. The method counts the number of properties that sold within 75 (30+45) days, dividing by the total number of properties. This is graphically represented as the number of crosses to the left of the red line in the histogram. The probability value of 33.7% means that the buyer thus has a 33.7% chance of purchasing a property (which has been on the market for 45 days) within 30 days.

FIG. 6B illustrates a scatter plot and associated calculations for home sales and calculations for determining the probability of selling a property within a given time. The seller inputs the time with which he or she would like to complete the transaction. The time can be defined as days on market, days on escrow, or total purchasing time, and thus the transaction can be defined as an offer acceptance or fully completed sale. The price is not a factor in this function. This implies that the seller will be reasonably interested in selling the property, and that his or her list price and offer acceptance will reflect that. A seller could potentially insist upon such high offers that he or she will never complete the sale. Therefore this functionality does not guarantee a sale, but rather provides the probability of transaction within a given time, pending reasonable offers. The method counts the number of properties that were transacted within a number of days that is less than or equal to the user inputted time. This count is then divided by the total number of properties, which gives the probability or purchasing the property within the specified timeframe.

FIG. 6B illustrates this with an example. In the example provided, the user enters 75 days on market as the desired timeframe. The number of properties to count is graphically represented as the number of crosses to the left of the red line, passing through the horizontal axis at 75 days. The probability value of 33.7% means that the seller has a 33.7% chance to sell the property within 75 days.

FIG. 7A illustrates a scatter plot and associated calculations for home sales and calculations for determining the probability of purchasing a property within a given time and determining the expected price for the purchase. In this function, the user inputs the timeframe within he or she would like to complete a property purchase, which can be defined as days on market, days on escrow, or total transaction time. The system will require the number of days the property has accumulated thus far, and the timeframe within which the buyer would like to complete the transaction, which can be defined as an offer acceptance or a completed purchase. The probability is the count of the number of properties that were sold in a number of days that is less than or equal to the user-specified timeframe, divided by the total number of properties. The expected price difference is the average price difference of the properties that were counted. This indicates to the buyer what price difference they can expect to buy for within their desired timeframe, and the probability associated with this scenario.

FIG. 7A illustrates this with an example. In the example provided, the property has been on the market for 45 days thus far, and the buyer wants to purchase within 30 days. The probability is found to be 33.7% and the mean price difference, which is the expected price difference, is 1.844%. This means that the buyer can expect to buy for 1.8444% off the list price in 30 days, with a 33.7% probability of this scenario actually occurring. This functionality may also be used by a seller whose property has been on the market for a number of days, to determine the expected additional number of days to sell.

FIG. 7B illustrates a scatter plot and associated calculations for home sales and calculations for determining the probability of selling a property within a given time and determining the expected sales price. In this function, the user inputs the timeframe, which can be defined as days on market, days on escrow, or total transaction time within he or she would like to complete the transaction, which can be defined as an offer acceptance, or fully completed sale. The system will require the number of days the property has been on the market thus far and the timeframe within which the user would like to complete the transaction. The number of days may be zero if the seller is just listing the home. The sum of these is the total timeframe. The probability is the count of the number of properties that were transacted in a number of days that is less than or equal to the user-specified total timeframe, divided by the total number of properties. The expected price difference is the average price difference of the properties that were counted. This tells the buyer what price difference they can expect to buy for within their desired timeframe, and the probability associated with this scenario.

FIG. 7B illustrates this with an example. In the example provided, the user wants to complete the transaction within 90 days, and the property has been on the market for zero days. The probability is found to be 62% and the mean price difference, which is the expected price difference, is found to be −2.877%. This means that the seller can expect to sell for 2.877% off the list price in 90 days, with a 62% probability of this scenario actually occurring.

FIG. 8A illustrates a scatter plot and associated calculations for home sales, and calculations for determining the probability of purchasing a property within a given time and at a given price difference. The buyer effectively inputs the maximum price he or she is willing to pay, specifying the relative price difference. The buyer may desire to know the probability that the offer will be accepted, within the buyer's target timeframe, which can be defined as days on market, days on escrow, or total transaction time. For the timeframe, the buyer must enter both the number of days the property has been on the market thus far, and the number of days within which the buyer wishes to complete the transaction, which can be defined as offer acceptance, or a finalized transaction. The specified timeframe is considered the sum of said time values. The method counts the number of properties that meet both of the following criteria:

1) The property was transacted for a price difference less than or equal to the specified price difference.

2) The property was transacted within a number of days that is less than or equal to the specified timeframe.

FIG. 8A illustrates this with an example. In FIG. 8A, 95% of the list price is assumed as the maximum price the buyer will pay, and that the property has been on the market for 50 days thus far. The buyer desires to purchase the property within 30 days. Thus, the method needs to determine the number of properties that sold at or below 95% of the list price and within the 80 days on market. In FIG. 8A, properties that meet both criteria occupy the rectangular region below the −5% horizontal line and to the left of the vertical 80 days line. In order to determine the desired probability, the number of properties within this region (within the subset) is counted. The count is divided by the total number of properties to give a probability of 23% for purchasing the property at or below 95% of the list price within 30 days of making an offer.

FIG. 8B illustrates a scatter plot and associated calculations for home sales and calculations for determining the probability of selling a property at a given price difference and within a given time period. The seller effectively inputs the minimum price that he or she is willing to accept, specifying the relative price difference. The seller may desire to know the probability that the property will be sold for at least the specified price, within the seller's target timeframe, which can be defined as days on market, days on escrow, or total transaction time. To accomplish this, the number of properties that meet both the following criteria are determined:

1) The property was transacted for a price difference greater than or equal to the specified price difference.

2) The property was transacted within a number of days that is less than or equal to the specified timeframe.

FIG. 8B illustrates this with an example. In the example in FIG. 8B, 95% of the list price is considered to be the minimum price the seller will accept. In the example provided, the seller would like to sell the property within 60 days. Thus, the number of properties that sold at or below 95% of the list price and within the 60 days on market are determined. In the graph in FIG. 8B, properties that meet both criteria occupy the rectangular region above the −5% horizontal line and to the left of the vertical 60 days line. Upon performing the process described above, it is determined that the buyer has a 7.3% chance to sell a property at or above 95% of the list price within 60 days of placing the property on the market.

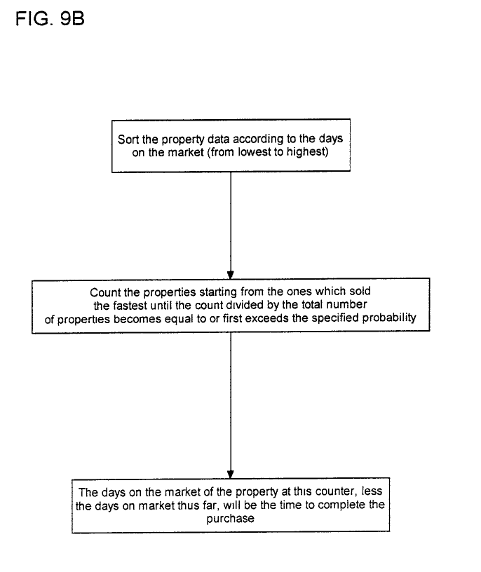

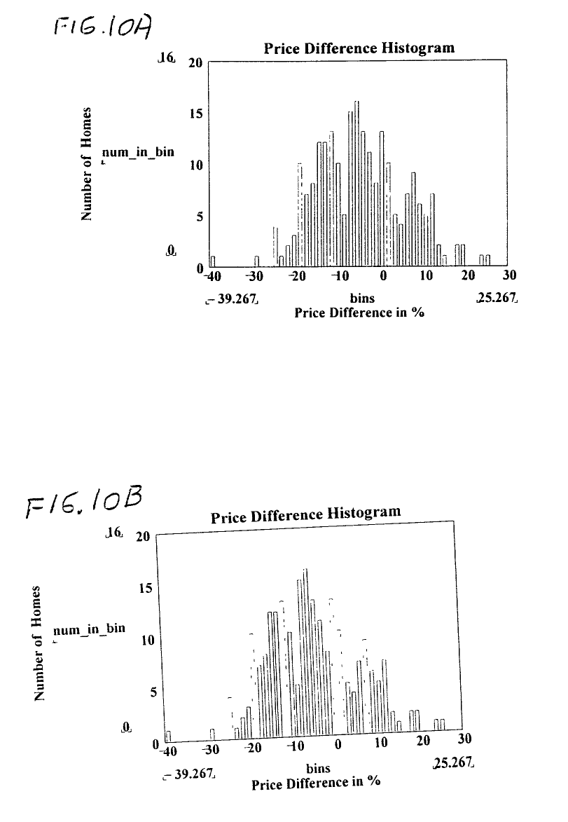

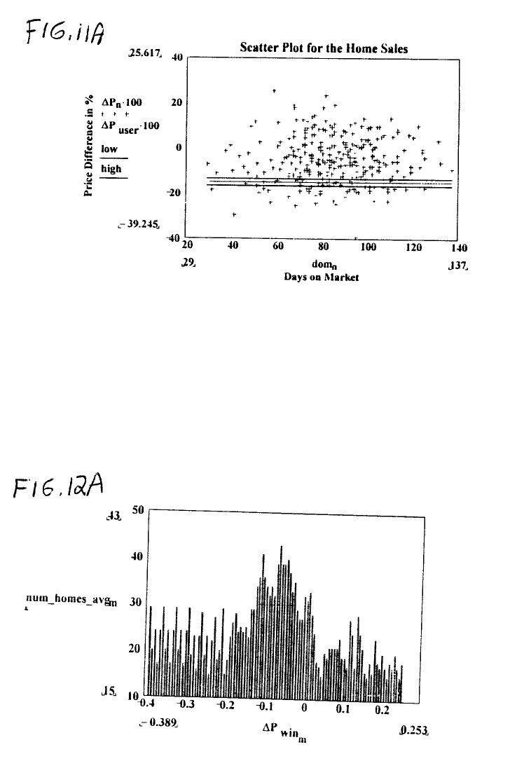

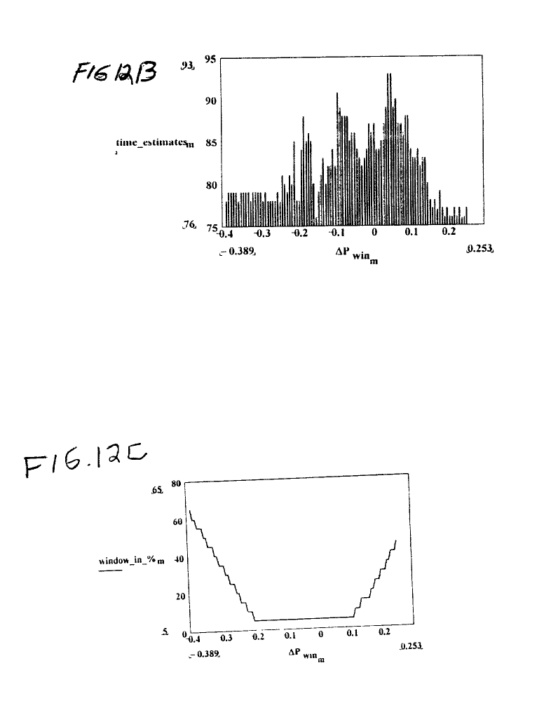

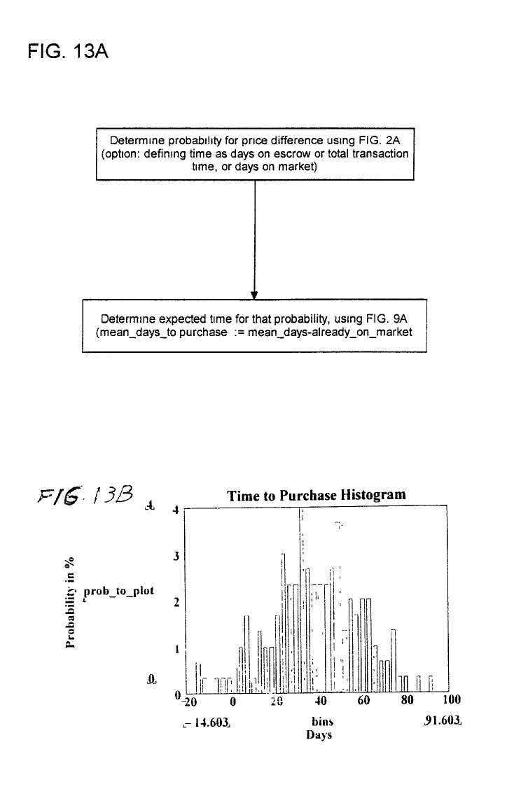

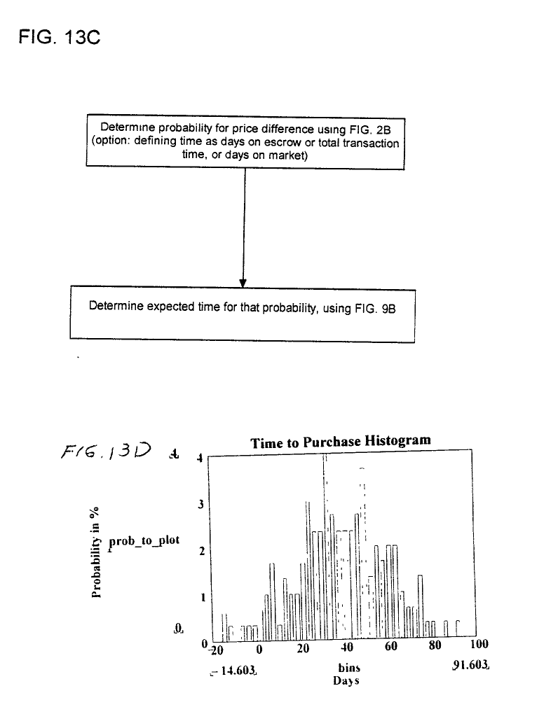

FIG. 9A illustrates a flow chart and calculations of determining the time to complete a purchase given the probability of buying a property. In this functionality, the buyer inputs the probability of buying the property, and the number of days the property has accumulated thus far. In this functionality, timeframe may be defined as days on market, days on escrow, or total transaction timeframe. The method starts by sorting the property data according to the timeframe, from lowest to highest. The functionality will then count the sorted properties, starting from the ones that sold the fastest, until the count divided by the total number of properties becomes equal to or first exceeds the specified probability. The time will be the timeframe of the property at which the counter is located when the count divided by the total number of properties becomes equal to or first exceeds the specified probability. The time, less the number of days the property has been on the market thus far, is the time used by the buyer to determine the time to complete the purchase.

FIG. 9A illustrates this with an example. In the example provided, the user enters 75% as the probability. The functionality determines that there is a 75% probability of the property being sold within 98 days on market. However, the property has been on the market for 45 days thus far. The buyer can thus expect the purchase of this particular property to be completed within 53 days from present. Note that this does not necessarily mean that this particular buyer will be the one that will purchase this particular property, but that this particular property will sell within 53 days with the probability of 75%.

FIG. 9B illustrates a flowchart and calculations of determining the time to complete a sale given the probability of selling a property. In this function, the seller inputs the probability of selling the property. Timeframe can be defined as days on market, days on escrow, or total transaction timeframe. The method will determine the time by first sorting the properties according to the timeframe, from lowest to highest. Next, the functionality will then count the sorted properties, starting from the ones that sold the fastest, until the count divided by the total number of properties becomes equal to or first exceeds the specified probability. The time used by the seller to determine the time to complete the purchase will be the timeframe of the property at which the counter is located when the count divided by the total number of properties becomes equal to or first exceeds the specified probability.

FIG. 9B illustrates this with an example. In the example provided, the user enters 75% as the probability. The functionality uses the process described above and determines that there is a 75% probability of the property being sold within 98 days on market.

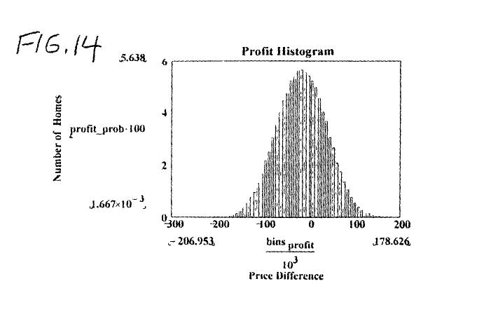

FIG. 10A is a price difference histogram and calculations for determining the time to complete a purchase and the price difference expected value given the probability of buying a property. In this function, the buyer inputs the probability of buying a property and the number of days the property has accumulated thus far, and requests the expected price difference and time, where time can be defined as days on market, days on escrow, or total transaction time, for this probability.

To determine the expected time, the timeframe for the specified probability is calculated by first sorting the properties according to the timeframe, from lowest to highest. The properties are then counted, starting from those which sold the fastest, until the count divided by the total number of properties becomes equal to or first exceeds the specified probability. The time will be the timeframe of the property at which the counter is located when the count divided by the total number of properties becomes equal to or first exceeds the specified probability. This time, less the number of days the property has accumulated thus far, is the expected time to complete the transaction, where said transaction may be defined as an offer acceptance, or a completely finalized transaction.

To determine the expected price difference, the properties that were counted in the expected time process above are used. The mean price difference determines the mean price difference as the expected price difference, and will also provide the standard deviation.

FIG. 10A illustrates this process with an example. In the example provided, the user inputs a probability of 75%, and the fact that the property has been on the market for 45 days so far. The functionality uses the processes above to tell the user that with 75% probability, a property that has been on the market for 45 days will be sold within 53 days (for a total of 98 days on the market) at the expected price difference of −4.847% (4.847% below the list price). In other words, a buyer offering the price 4.847% below the list has a 75% chance of purchasing the property within 53 days.

FIG. 10B is a price difference histogram and calculations for determining the time to complete a purchase and the price difference expected value given the probability of selling the property.

In this function, the seller inputs the probability of selling a property and the number of days the property has accumulated thus far, and requests the expected price difference and timeframe, where timeframe can be defined as days on market, days on escrow, or total transaction time, for this probability.

To determine the expected timeframe, the method will first calculate the time for the specified probability, by sorting the properties according to the timeframe, from lowest to highest. The method will then count the properties, starting from those which were transacted the fastest, until the count divided by the total number of properties becomes equal to or first exceeds the specified probability. The timeframe will be the timeframe of the property at which the counter is located when the count divided by the total number of properties becomes equal to or first exceeds the specified probability. This time, less the days so far, is the expected timeframe.

To determine the expected price difference, the method will use the properties that were counted in the expected time process above. The method will determine the mean price difference as the expected price difference, and will also provide the standard deviation. The expected price difference will be used with the equation shown in FIG. 10B to provide the list price associated with that probability. Alternately, the expected price difference could be accumulated onto the list price, to provide the sales price associated with that probability.

FIG. 10B illustrates this process with an example. In the example provided, the user inputs a probability of 75%. The functionality uses the processes above to tell the user that, with a 75% probability, the property will be sold within 98 days on the market at the expected price difference of −4.847%. In other words, the user is told that a list price that is 4.404% above the target sales price provides a 75% chance of selling the property within 98 days.

FIG. 11 is a scatter plot and calculations for home sales for determining the estimated time for transacting a property at a given price difference. This functionality is essentially the same for buyers and sellers. Time can be defined as days on market, days on escrow, or total transaction time. The difference is that the buyer functionality subtracts the time accumulated thus far for the specific property and the seller, if placing the property on the market initially, does not. This functionality uses a moving average, which is essentially an interpolation on the data. The user specifies the relative price difference. The user would like to know the expected (average) time to complete the transaction, which can be defined as an offer acceptance, or a completely finalized transaction, assuming that the event will happen. The probability of the event happening does not figure in this functionality. The user also inputs the number of days the property has accumulated so far, if applicable.

The method begins by determining the minimum and maximum price differences among the properties. The range of price difference is defined as the difference between the values. Next the method determines the minimum number of properties needed to be able to perform reasonable timeframe averaging. There are three ways to define this number. First, the number may be defined as a fraction of the total number of properties (for example: N/10). Second, the number may be defined as a fixed number (for example: 10). Third, the number may be defined as dependent on the numerical values. For example, this could be N/10 if N/10>10, 10 if N/10<10 but N>10, and N if N<10.

Ideally, the initial strip width should be a function of the distribution of the price difference data, and the user defined price difference. If the user-specified price difference falls in a region of low density of data points, the initial strip width should be larger, while if the user-specified price falls in the region of high data point density the initial strip width should be smaller. In this way the number of properties within strips (of different width) are approximately the same, while for a constant strip width it varies with strip position, which is determined by the user-specified price difference.

The basic algorithm is to define the initial strip (or “window”) of properties to consider, where the strip represents a rectangular area in a scatter plot, such as that in the example shown in FIG. 11A, and where the strip width is centered at or near the user's price difference. The width of the initial strip is defined as a function of the range of price differences and the minimum number of properties needed in each strip to be able to average. The functionality will count the number of properties in the strip, and divide by the total number of properties overall. While the count of properties is less than the number needed to reach the target probability, as defined by the pool size, the functionality will increase the strip width linearly. This can be done by adding half of the initial strip width above, and half below, so that respective strip widths would be 1 times the original strip width, 2 times the original strip width, 3 times the original strip width, etc. As the algorithm goes through this process, it will store the following information for each window: the average days on market in the window, the number of properties in the window, the lower limit of the window, and the upper limit of the window.

When the target probability is reached or exceeded, the method will stop and will return the corresponding days on market. The method could also interpolate to provide the days on market at the exact probability value.

In the example shown in FIG. 11, the user entered a price difference of −15%, and the minimum, maximum and range of price differences for the properties were found. In this example, the variable titled “pool_to_average” defines the minimum number of properties needed in each strip. The width of the initial strip is defined as a function of the range of price differences and the minimum number of properties needed in each strip to be able to average. In the example shown in FIG. 11, the scatter plot shows a sample strip, and the variable titled “time_and_count” shows the resulting estimated time on market, the count needed to attain that value, and the low and high limits of the strip respectively.

FIGS. 12A-12C illustrated graphs and calculations for determining time and price differences. This functionality plots information describing the relationship between timeframe and price difference. The functionality will use a process that can be referred to as sliding window averaging. The basic algorithm is to move the windows (or “strips”) of property data in the scatter plot over all possible window positions, and to determine the average price change for each window, as in FIG. 11. The functionality will then plot the histogram with the average days on market for the window as the y value, and the price change around which the window is centered as the x value. The number of properties does not affect the number of windows that should be used, but the graph becomes less accurate when there are fewer properties. The number of windows can be selected as an arbitrary constant (this is 100 in the example shown in FIGS. 12A-12C), but the method does need to specify the window-to-window increment, which is the distance between the center of each window to the center of the next window. The window-to-window increment is defined as the ratio of the range of price differences to the number of windows. The center of each window is defined in the same manner as that which is shown in the example. In the equation labeled “Window Center,” m is an index that goes from 1 to the number of windows.

In the preferred embodiment, the functionality stores the following information about each window: the average days on market, the number of properties in the window, the lower limit of the window, as a price difference, and the upper limit of the window, as a price difference. The graphs presented include:

1) The central price difference for the window (x) versus the average days on market in each window (y);

2) The number of properties (y) in each price difference window (x); and

3) (optionally): the percentage increase in window size for each price difference window.

FIG. 13A illustrates a flow chart and calculations for determining the expected time to complete the purchase. FIG. 13B illustrates a time to purchase histogram for FIG. 13A. The system will require the maximum price difference and (if applicable), the number of days the property has accumulated so far. The method first determines the probability that corresponds to that price, by using the process described in FIG. 2A. The expected time to complete the transaction is then determined, by using the process described in FIG. 9A. Time can be defined as days on market, days on escrow, or total transaction time, and similarly, the transaction can be defined as an offer acceptance, or a completely finalized transaction.

FIG. 13C illustrates a flow chart and calculations for determining the expected time to complete a sale. FIG. 13D illustrates a time to purchase histogram for FIG. 13C. The user inputs the minimum price difference and (if applicable), the number of days the property has been on the market so far. First, it is determined the probability that corresponds to that price, by using the process described in FIG. 2B. Next, the expected time to complete the transaction is determined, by using the process described in FIG. 9B. Time can be defined as days on market, days on escrow, or total transaction time, and similarly, the transaction can be defined as an offer acceptance, or a completely finalized transaction.

FIG. 14 illustrates a profit histogram and calculations for determining the expected profit for a dual transaction scenario. In this functionality, the user is seeking information about profit in a dual-transaction situation, in which the user is buying one property and selling another. The user wishes to know the expected profit or loss. The property that the user is selling may not be in the same subset as the property the user is buying, meaning that different database queries may need to be made for the property being sold and the property being bought. Therefore, two data files may be needed, one for the property being sold and one for the property being purchased.

The method begins by processing each file: the data set of properties that are similar to the one that the user is considering purchasing, hereafter referred to as the buying pool; and the data set of properties that are similar to the one that the user is considering selling, hereafter referred to as the selling pool. In this function, the user does not input any specific prices (such as a target purchasing or selling price, or a list price).

The method first determines the average list price and average sales price for the properties in the buying pool, and for the properties in the selling pool. The method then considers the profit represented by all pair combinations, and determines the mean profit. The method may then consider the sum of the profit represented by the pair combinations, and may determine the mean profit by dividing by the number of pair combinations.

This process is done by subtracting the list price from the sales price for each property in the buying pool, and for each property in the selling pool, thus providing the profit for each property. Next, the aforementioned profits for both properties (buying and selling pool properties) are added in the buy/sell pair, giving the expected profit for the buy/sell pair. This information is stored for later use. This process is performed for all possible buy/sell pairs (combinations) and the sum of the expected profits for the pairs is divided by the number of buy/sell pairs, to provide a value for expected profit.

FIG. 14 illustrates this with an example, in which the above process is run on sample data, and it is determined that the user can expect to pay a factor of 17296 more for the purchase than they receive from the sale.

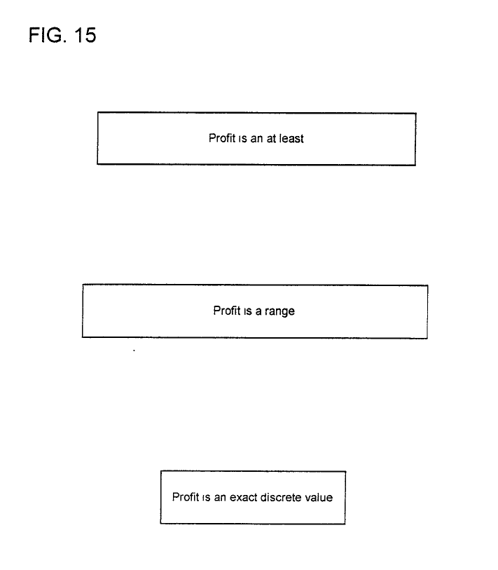

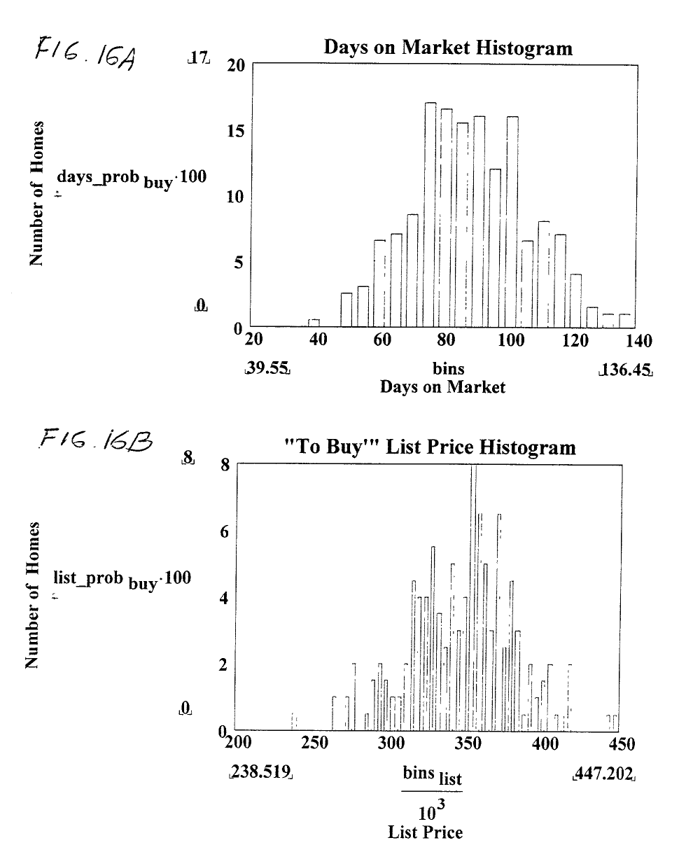

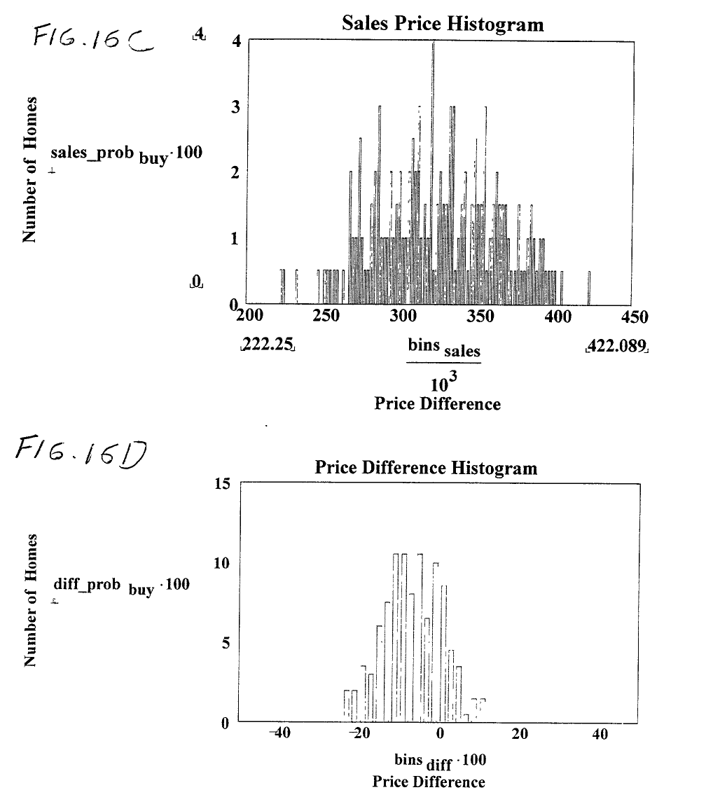

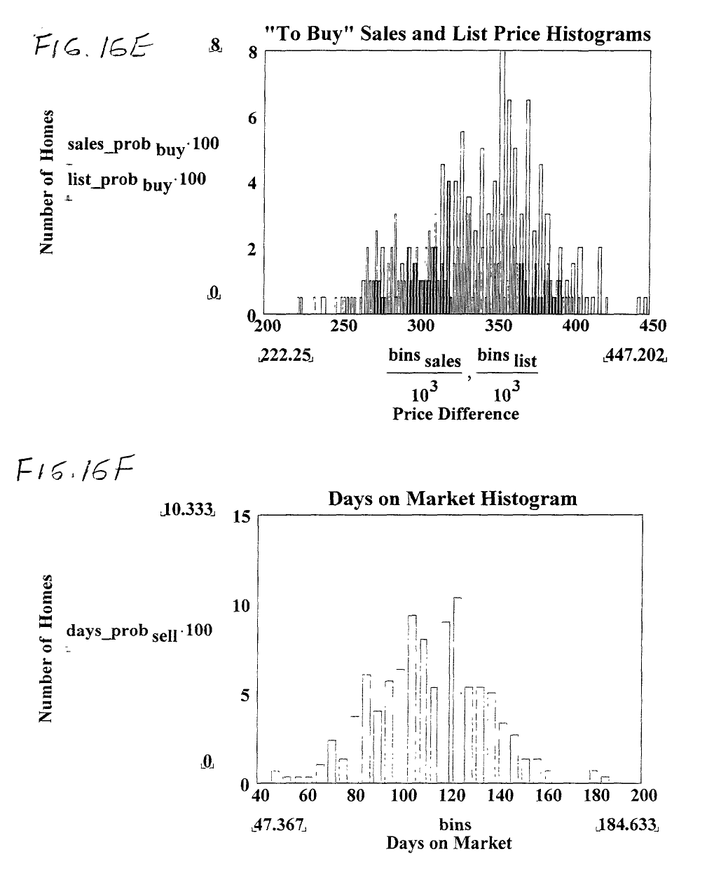

FIG. 15 illustrates the calculations necessary for determining the probability of a certain profit in a dual transaction scenario for a buyer and seller. In this functionality, the user wishes to know the probability of making a given profit in a dual transaction scenario. If the desired profit is defined as a minimum (“at least”) value, this is determined by using the data from the buy/sell profit pairs, as described in FIG. 14, and by counting the number of occurrences of a profit (in the buy/sell profit pairs) that is greater than or equal to the user-specified profit, and dividing said number of occurrences by the total number of buy/sell profit pairs. If the profit is a range value (meaning that the user wants the probability of a profit within a range), the probability will be determined by counting the number of occurrences within the range, and dividing this value by the total number of buy/sell profit pairs. FIG. 15 illustrates the 3 possible options for the type of probability using the above analyses on sample data.

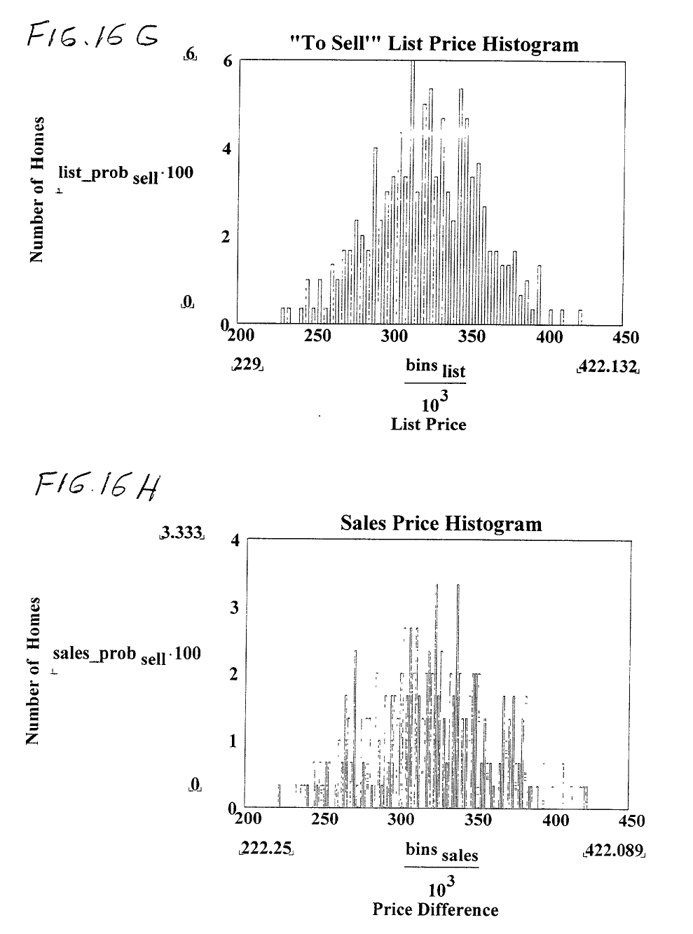

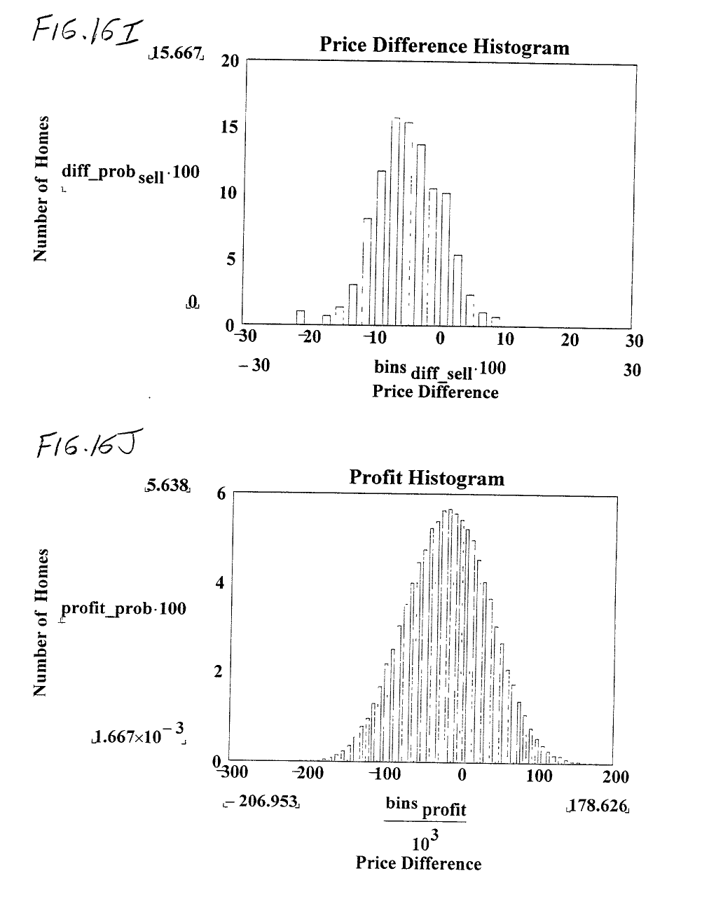

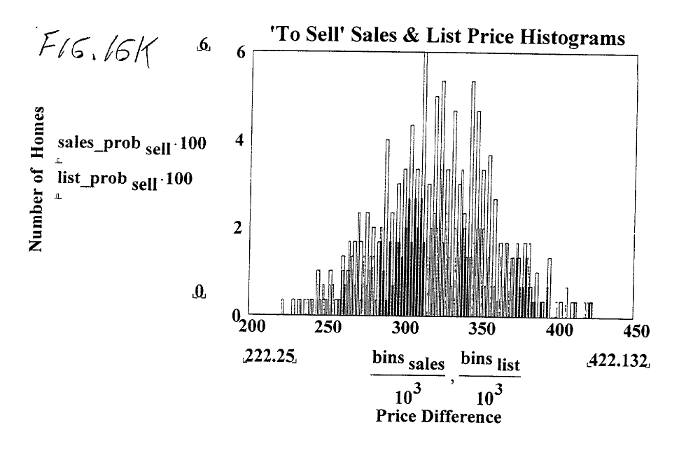

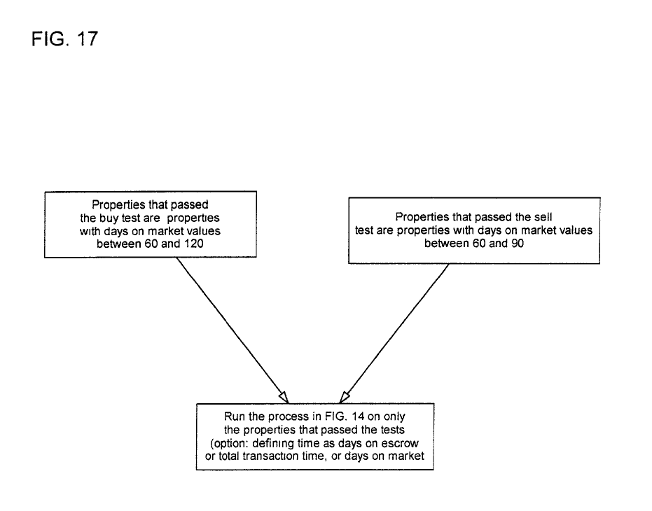

FIGS. 16A-J illustrates scenario graphs related to a dual transaction scenario functionality. The method provides the graphs that relate to one or both of the pools (buying and selling pools), based on the dual-transaction scenario functionality. The appropriate graphs of this set may also be provided for the other disclosed functionalities. These graphs may include one or more of the profit-related data items. Examples are provided in the figure.

FIG. 17 illustrates a flow chart and calculations for determining the expected profit for a dual transaction scenario, under time constraints. In this functionality, the user is seeking information about expected profit in a dual-transaction situation, in which the user is buying one property and selling another, and where the user has placed time constraints on the purchase and sale. The property that the user is selling may not be in the same subset as the property the user is buying, meaning that different database queries may need to be made for the property being sold and the property being bought. Therefore, two data files may be needed, one for the property being sold and one for the property being purchased.

The method begins by processing each of the following: the data set of properties that are similar to the one that the user is considering purchasing, hereafter referred to as the buying pool, and the data set of properties that are similar to the one that the user is considering selling, hereafter referred to as the selling pool. In this function, the user does not input any specific prices (such as a target purchasing or selling price, or a list price). The user inputs the number of days the property has accumulated, and the number of days in which they wish to complete the transaction (either days on market, days on escrow, or total transaction time), for both the property the user is considering purchasing, and the property the user is selling. The timeframe requirements may be different for the buy and sell portions of the dual-transaction scenario.

The expected profit is determined by the method described in FIG. 14. However, the FIG. 14 functionality will only be performed on the properties (both buying and selling pool properties) that met the timeframe requirements for the pool, meaning that the property's time value will be between the values the user inputted for time thus far, and target total time (target additional days plus days so far). This process is outlined using example time constraints in FIG. 17.

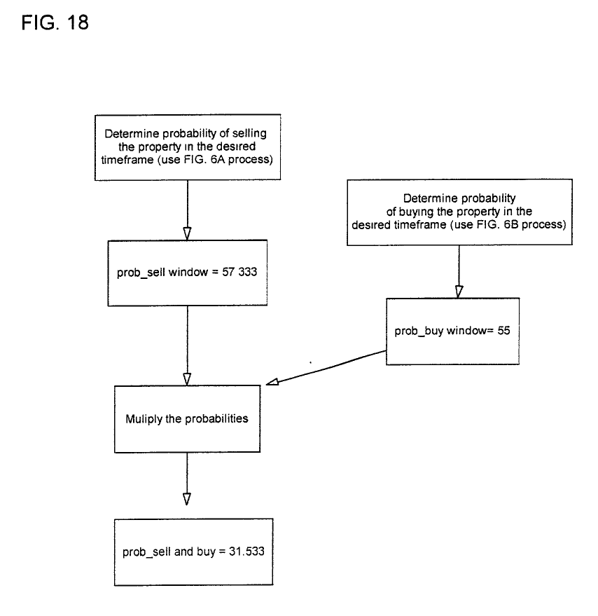

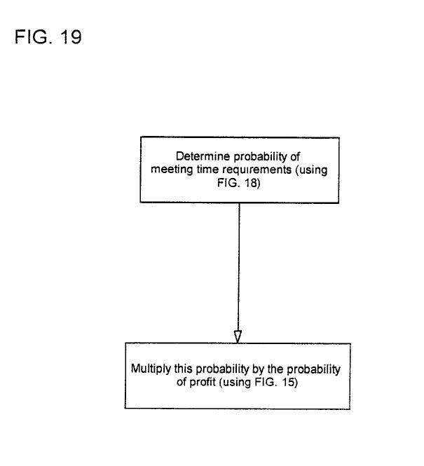

FIG. 18 is a flow chart and calculations for determining the probability of completing two transactions in a target timeframe for each transaction. The method determines probability of the buying timeframe requirements and of the selling timeframe requirement, by using the process described in FIGS. 6A and 6B respectively. The probabilities corresponding to the timeframes are multiplied, to provide the combined probability. This is the probability that the user will be able to buy within their desired buy timeframe, and will be able to sell within their desired timeframe. This process is outlined in FIG. 18, with example input and output provided, based on example data.

FIG. 19 illustrates a flow chart for determining the probability of a certain profit in a dual transaction scenario under time constraints. The method determines the probability of meeting the time constraints as determined in FIG. 18. Alternately, this could be found by selecting only those properties that met the timeframe requirements, and running the functionality provided in FIG. 15 on the properties.

If the determined probability is greater than zero, the method determines the probability of the desired profit, using the process described in FIG. 15. The two probabilities are multiplied, which provides the probability of both events.

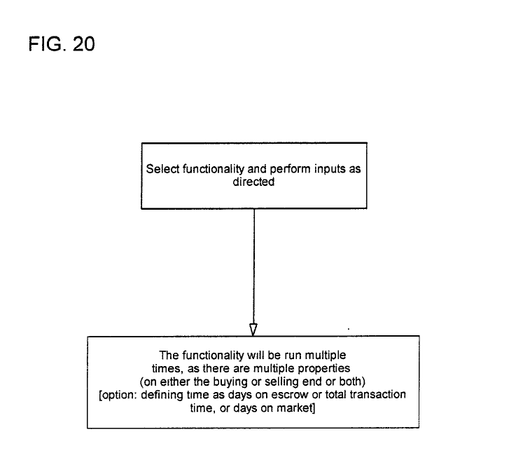

FIG. 20 illustrates a flow chart for running a functionality from FIGS. 14-19 on a total dual transaction scenario. The user selects a functionality (from FIGS. 14-19). The functionality is run multiple times (internally), to provide the answer(s) for the total dual transaction scenario.

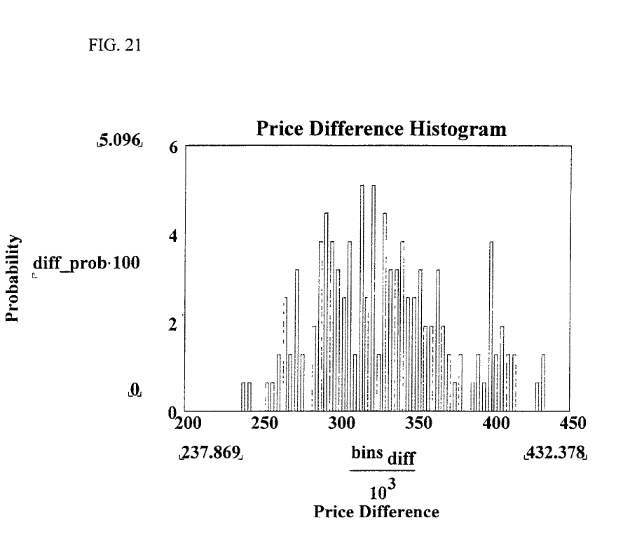

FIG. 21 illustrates a price difference histogram and calculations for determining a price for time. The user may enter the number of days the property has accumulated thus far, and the target number of additional days in which they wish to have an offer acceptance or transaction completion. The method isolates the data for the properties that have time values within the user's time constraints (between days thus far and target total time, the latter being defined as days thus far plus target additional days) and determines any of the following values for the applicable data (the applicable data meaning the data that met the time constraints).

1) The average (most likely) additional days, which is defined as the average timeframe from the applicable data, minus the days the particular property has been on the market thus far.

2) The average sales price, and/or average list price and/or average price difference.

The average sales price may be used to provide the expected sales price for the timeframe and the average list price to provide the expected list price for the timeframe. This process is illustrated by the example in FIG. 18, which uses example inputs and data. The example indicates that the expected sales price is 329,142 and the expected list price is 353,982 .

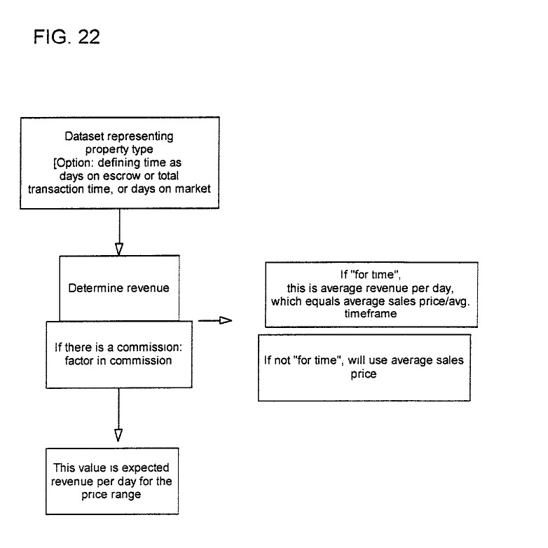

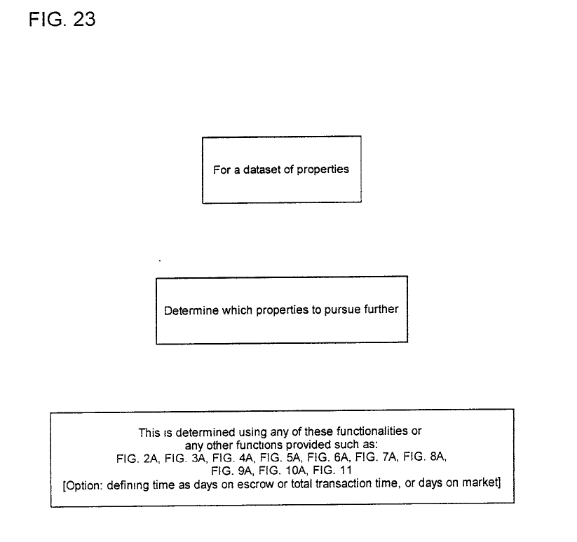

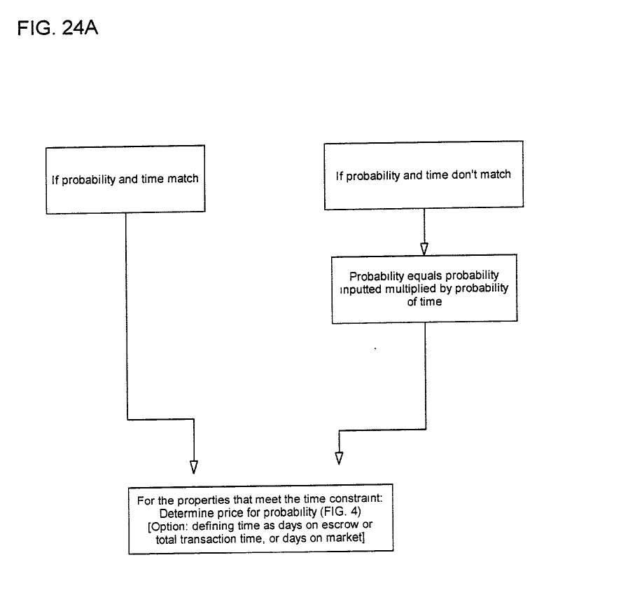

FIG. 22 is a flow chart illustrating the steps for determining which price range of properties provides the highest revenue. The data sets from the user are inputted, each data set consisting of data for properties in a specific price range or type of property. The method determines the average sales price for properties in the file, and divides this by the average transaction timeframe (days on market, days on escrow, or total transaction time). The professional's commission percentage is factored in, if applicable, to provide the revenue, or revenue per day, in the price range. Expenses can also be subtracted. The method stores this value for each of the user's property type files, and presents the stored info, highlighting which type of property had the highest expected revenue or revenue per day. FIG. 22 illustrates this with an example calculation on example data.

FIG. 23 is a flow chart illustrating for determining price, time, and probability characteristics of multiple properties. The method, takes in a data set of properties that are available. The user makes determinations on the properties to assist in determining which property(s) are worth pursuing further. The method may run one or more of the functionalities in the properties, depending on what factors the user wishes to consider.

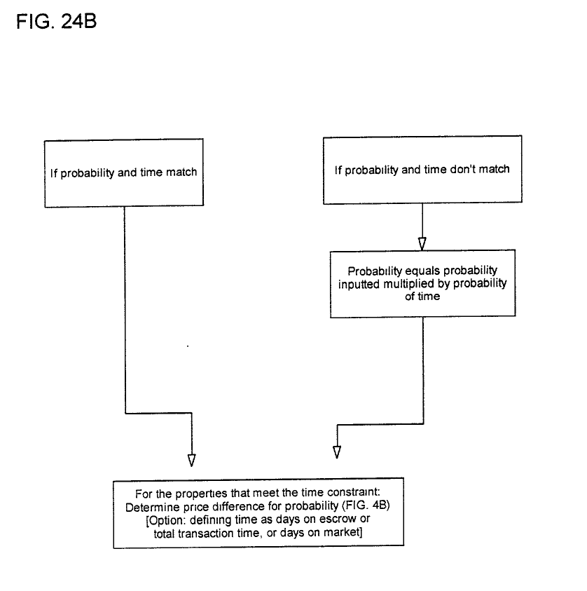

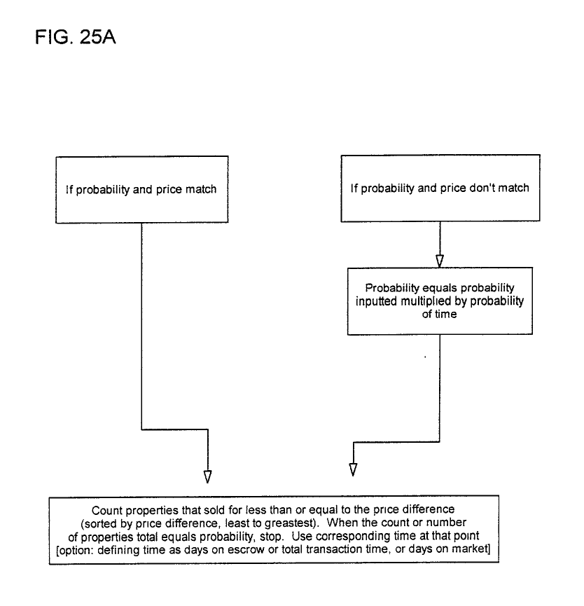

FIG. 24A is a flow chart illustrating the steps for determining price for probability and time for a buyer. The user enters a timeframe for the transaction (where the timeframe may be defined as days on market, days on escrow, or total transaction time, and where the transaction may be defined as an offer acceptance or a finalized transaction), the list price, and also a probability.

The probability entered by the user may be different from the actual probability of the timeframe. If this is the case, the probability is considered a conditional probability, meaning that the probability of the timeframe is multiplied by the user-inputted probability, to determine the actual probability that will be used to determine the price.

The method sorts the properties (that meet the time constraint) by price difference, from least to greatest, and will count the sorted properties until the count divided by the total number of properties overall reaches or exceeds the target probability. The corresponding price difference is accumulated onto the list price of the property and presented.

If the user-inputted probability is not different from the actual probability of the timeframe, the method simply performs the sorting, count and interpolation as above, without the multiplication of probabilities.

FIG. 24B illustrates a flow chart illustrating the steps for determining a price for probability and time for a seller. The seller enters a timeframe for the transaction (where the timeframe may be defined as days on market, days on escrow, or total transaction time, and where the transaction may be defined as an offer acceptance or a finalized transaction), a list price or target selling price, and also a probability.

The probability may be different from the probability of the timeframe. If this is the case, the probability is considered a conditional probability, meaning that the probability of the timeframe is multiplied by the user-inputted probability, to determine the actual probability that will be used to determine the price. The method sorts the properties (that meet the time constraint) by price difference, from greatest to least, and counts the sorted properties until the count divided by the total number of properties overall reaches or exceeds the target probability. The corresponding price difference is either factored into the list price of the property (if the seller inputted a list price) to provide a sales price for the probability and time combination or is factored into the target selling price (if the seller inputted a target selling price) to provide a list price for the probability and time combination.

If the user-inputted probability is not different from the probability of the timeframe, the method simply performs the sorting, count and interpolation as above, without the multiplication of probabilities.

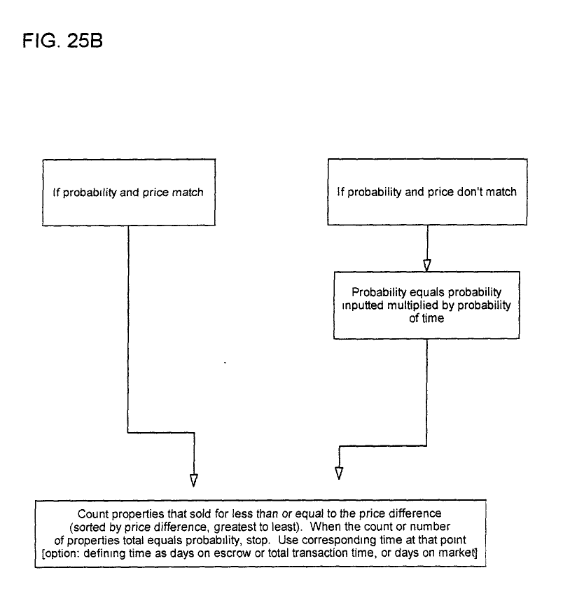

FIG. 25A is a block diagram illustrating the functionality for determining time for price and probability for a buyer. The user inputs a price difference and probability combination, and requests the timeframe for a transaction with this combination, where the timeframe can be defined as days on market, days on escrow, or total transaction timeframe, and where the transaction can be defined as an offer acceptance or a finalized transaction. If the price and probability combination is a not an actual combination based upon the data, the method multiplies the probability of the inputted price by the inputted probability. This gives the conditional probability. If the price and probability combination is an actual combination based upon the data, the multiplication is not performed.

The method counts the properties that sold for price differences less than or equal to the user-inputted price change, starting from the properties with the lowest timeframe and continuing upwards, until the count divided by the total number of properties overall is greater than or equal to the probability. The method may then interpolate based on the probability and time, using the interpolation functionality to be described in FIG. 41, to determine the expected time.

FIG. 25B illustrates a block diagram for determining the time for price and probability of a seller. The user inputs a price difference and probability combination, and requests the timeframe for a transaction with this combination, where the timeframe can be defined as days on market, days on escrow, or total transaction timeframe, and where the transaction can be defined as an offer acceptance or a finalized transaction. If the price and probability combination is a not an actual combination based upon the data, the method multiplies the probability of the inputted price by the inputted probability. This gives the conditional probability. If the price and probability combination is an actual combination based upon the data, the multiplication is not performed.

The method counts the properties that sold for price differences greater than or equal to the user-inputted price change, starting from the properties with the lowest timeframe and continuing upwards, until the count divided by the total number of properties overall is greater than or equal to the probability. The method then interpolates based on the probability and time data, to determine the expected time.

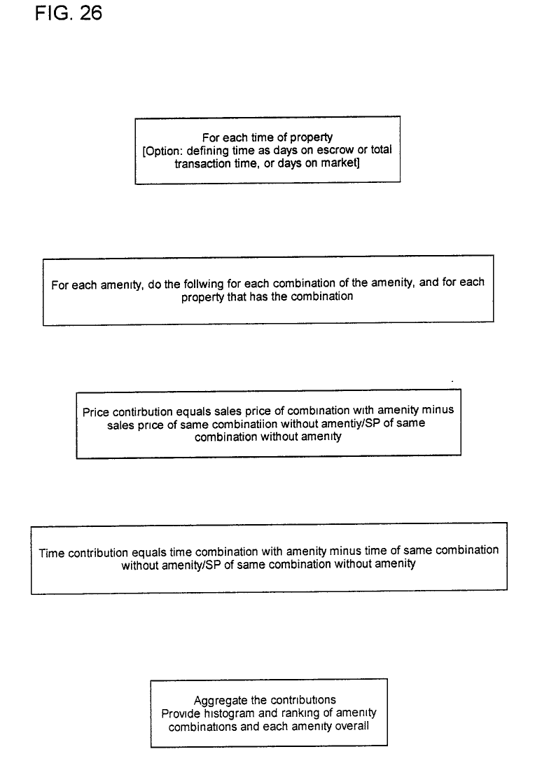

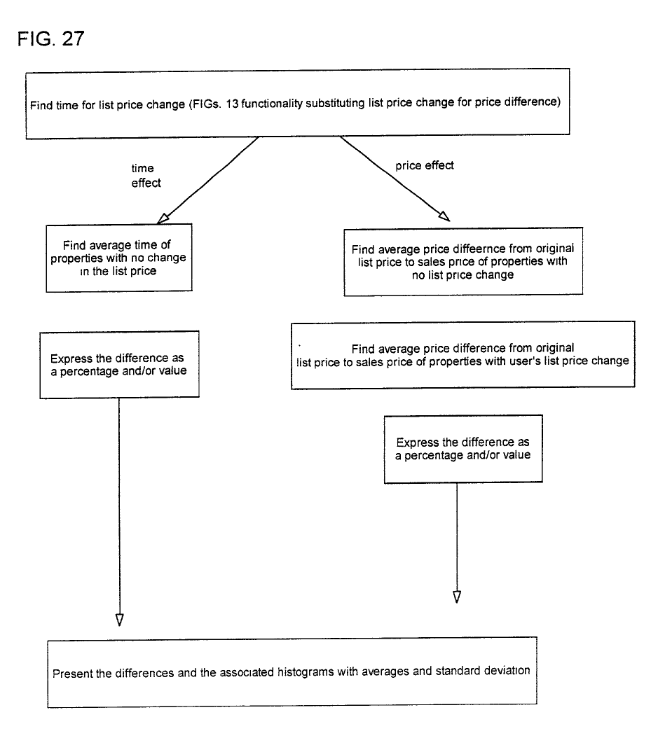

FIG. 26 is a block diagram for determining the amenities or characteristics that are most important in a property. This method evaluates amenities based upon their contribution to the speed and revenue of property sales. Amenities refer to the characteristics of the property. The method determines which amenity contributed most to the time and price of properties in the property types. For each property type, the method performs the following price and time evaluation process.

To determine an amenity's contribution to price, the method subtracts the sales price of each property that had the amenity being evaluated (and potentially some combination of other amenities), from the sales price of each property that had all of the amenities of the aforementioned property, except the amenity being evaluated. For example, for Amenity A, the process would consider the sales price of Property with ABC, subtracting sales price of Property with BC. In the preferred embodiment, this difference is expressed as a percentage value, and may be graphed in a histogram, where the average and standard deviation of the price contribution percentage of the amenity (in that amenity combination) is provided. The method may also create a similar histogram for the amenity in all combinations.

To determine an amenity's contribution to time, the method subtracts the timeframe (either days on market, days on escrow, or total transaction time) of each property that had the amenity being evaluated (and potentially some combination of other amenities), from the corresponding timeframe of each property that had all of the amenities of the aforementioned property, except the amenity being evaluated. This difference expressed as a percentage value, and may be graphed in a histogram, where the average and standard deviation of the time contribution percentage of the amenity (in that amenity combination) may be provided. The method also creates a similar histogram for the amenity in all combinations. The method may output the contribution to time and price for all of the amenities and amenity combinations, and highlight the best amenity overall, and best amenity combination (for the property type).

FIG. 27 is a block diagram illustrating the functionality for determining the effect, in terms of price and time, of changing the list price for a seller. The user may contemplate changing the list price of the property by a certain amount and may desire to evaluate the effect of such a change on the time and price characteristics of a sale. To evaluate the time effect, the method determines the timeframe (where timeframe can be in terms of days on market, days on escrow, or total transaction time) for the properties that had a list price change, using the functionality described in FIG. 13A, but substituting list price difference for price difference. The method may also determine the average timeframe (where timeframe can be in terms of days on market, days on escrow, or total transaction time) for properties that had no change in list price. The method determines the difference between these timeframes (the timeframes of properties that had a change in list price, and those that didn't), as a percentage.

To evaluate the price effect, the method determines the average price difference (from original list price to sales price) of properties that had a list price change within some small percentage range of the user-inputted list price change and also determines the average price difference (from original list price to sales price) of properties that have no list price change. The method determines the difference between these averages, and expresses the difference as a percentage.

The time and price difference percentage differences may be outputted to the user (the price difference percentage can also be outputted in dollar terms, using the average original list and sales price), along with histograms of list price change, price difference, and time, with standard deviation and average values also provided.

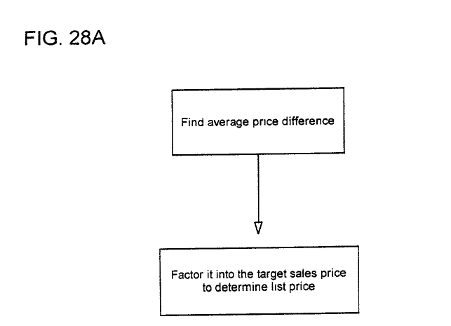

FIG. 28A illustrates a block diagram for determining a list price for target sales price for a seller. The method determines the average price difference for the similar sold properties, and factors this value into the target sales price, to determine a reasonable list price for attaining the target sales price. Probability and time are not factors.

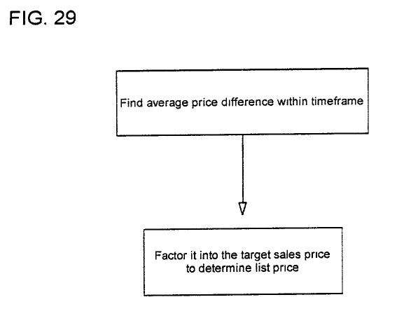

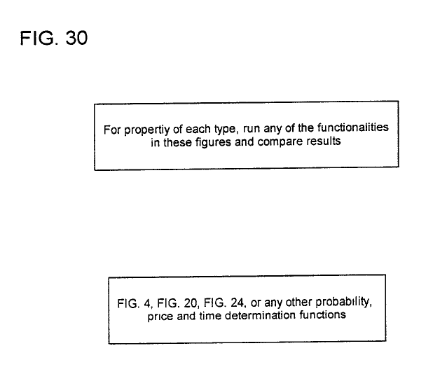

FIG. 29 is a chart for determining list price for target sales price and time for a seller. The method determines the average price difference for the similar sold properties that transacted within the user-specified timeframe (where timeframe can be in terms of days on market, days on escrow, or total transaction time), and factors this value into the target sales price, to determine a reasonable list price for attaining the target sales price. Probability and time are not factors.

FIG. 30 is a block diagram illustrating the steps for comparing expected price and other key information for similar properties where one or more variables differ. In the preferred embodiment, the method performs the functionalities of determining price for probability (FIG. 4), determining price for probability and time (FIG. 24), determining price for time (FIG. 21), or other suitable functionalities for a property with one value for a variable, and for a very similar property where that variable has a different value (e.g., different locations). The prices may be presented and compared, to give the user a quantitative perspective on the relative pricing levels of similar properties where one value differs (e.g., location). The user can also run any of the other functionalities disclosed, to make additional determinations. For example, the property type with the highest average price difference may be determined. If the user is a seller, the seller versions of the functionalities may be used, and if a buyer, the buyer versions may be used.

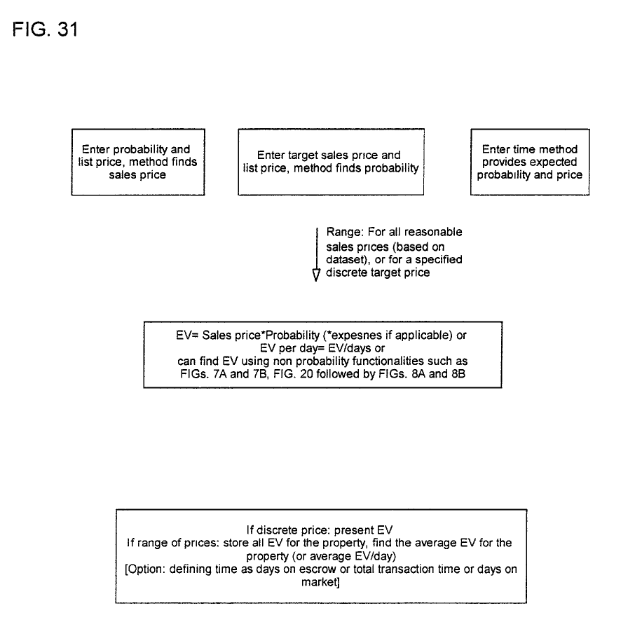

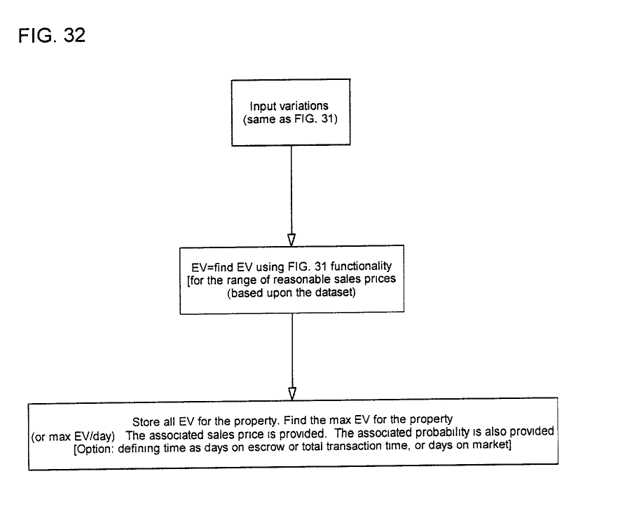

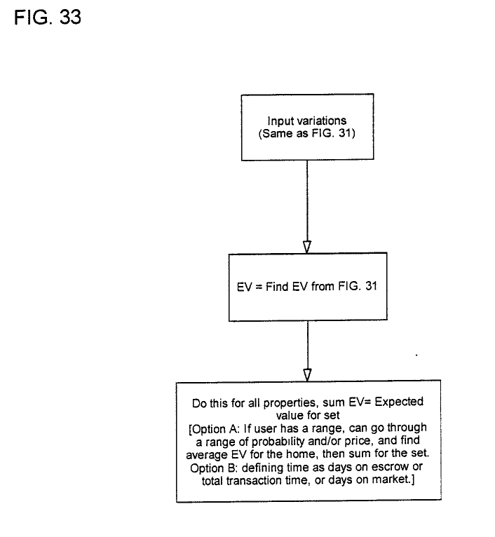

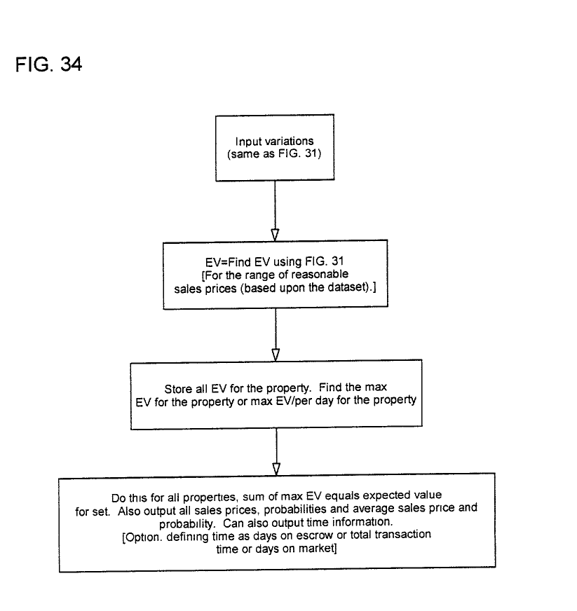

FIG. 31 is a block diagram illustrating the steps for determining expected value for a property for a seller. If the user desires to solve using a discrete price level, the user inputs the list price and initial (minimum) target sales price of each property in the transaction set. The method determines the probability of the price difference (the difference between the list price and target sales price) within the user-specified timeframe (where timeframe can be defined as days on market, days on escrow, or total purchasing time). This may be calculated as described in FIG. 8B.

Alternately, the user may input an initial (minimum) probability and a list price, and the method may determine the sales price for this combination and timeframe, using the functionality described in FIG. 24B, or can find the sales price and time for a probability, using the functionality described in FIG. 10B.

If a timeframe is not selected, the method simply determines a probability for the inputted target price, or price for the inputted target probability, as described in the FIG. 2B or 4B respectively. In either case, the method multiplies the probability by the target sales price of the property, which provides the expected value for the property.

If this functionality is needed from the buying perspective, the method follows the process discussed above, but may use the functionalities described in FIG. 8A, FIG. 9A, or FIG. 24A, and/or FIG. 2A or FIG. 3A. If the user wishes to solve across a range of prices, the method continues determining expected values of all sales prices within the range of inputs that are less than or equal to the maximum reasonable value, as defined by the input data set of similar sold properties.

In any case, each expected value is stored. In the case of a range, the multiple expected values are averaged. The method also allows the user to adjust their preference toward a certain percentage more or less in price and/or time. This adjusts the list and sales price for each property, and the timeframe, by the corresponding percentage, pending that both the list and sales prices remain in the range of the input file. However, if the list and sales prices do not remain in the range of the input file, they are increased by the maximum percentage that will allow them to remain within the range of the input file.

The method also allows the user to input predicted expenses for the dealing with the properties, to determine the expected net income. In another option for this function, if the user does not wish to input any probability or price information, the method can use any functionality. For example, these can be provided from other information, such as time.

FIG. 32 is a block diagram illustrating a functionality of maximizing expected value of a sale or maximizing expected value per day for a sale. To maximize revenue with one property, the method may perform the following expected value maximization. If the user desires to solve using a set price level, the user inputs the list price and initial (minimum) target sales price of each property in their transaction set. The method determines the probability of the price difference (the difference between the list price and target sales price) within the user-specified timeframe (where timeframe can be defined as days on market, days on escrow, or total purchasing time). This process is discussed in FIG. 8B.

Alternately, the user may input an initial (minimum) probability and a list price, and the method then determines the sales price for this combination and timeframe, using the functionality described in FIG. 24B, or can find the sales price and time for a probability, using the functionality described in FIG. 10B.

If optimization within a timeframe is not selected, the method may simply determine probability for the inputted target price, or price for the inputted target probability, as described in the FIG. 2B and FIG. 4B respectively. In either case, the method multiplies the probability by the target sales price of the property, which provides the expected value for the property.

If this functionality is needed from the buying perspective , the method will be as described above, but will use the functionalities described in FIGS. 8A, 10A, 24A, 2A, or 4A. If the user wishes to solve across a range of prices, the method continues determining expected values of all sales prices within the range of inputs that are less than or equal to the maximum reasonable value, as defined by the input data set of similar sold properties.

In any case, each expected value is stored, and the maximum of the expected values is found. The sales price corresponding to this expected value is stored. The method also allows the user to adjust their preference toward a certain percentage more or less in price and/or time. This adjusts the initial (minimum) list and sales price for the property, and the timeframe, by the corresponding percentage, pending that both the list and sales prices remain in the range of the input file. If not, they are increased by the maximum percentage that will allow them to remain within the range of the input file.

If the user wishes to maximize revenue per day (this can be per day on market, per day on escrow, or per day over the entire course of working with the property), the method is the same as described above, but will use the functionality described in FIG. 5A or 5B (if probability is provided) or FIG. 3A or 3B (if price information is provided) to determine the price/probability combination that is multiplied to provide expected value for the property. The aforementioned functions also provide the expected time. Dividing expected value by expected time provides expected value per day. All information features are provided as for the maximization of expected value, but in this case they are providing information that includes time, such as the average revenue per day.

FIG. 33 is a block diagram for determining the expected value of a set of transactions. This method employs the Find Expected Value of Property functionality, provided in FIG. 31, for each property. The method will do this process for all the properties in the user's set, summing the expected values, to provide an overall expected value for the set. When using the range method (specifying a range of acceptable prices, by specifying a maximum price), there will be multiple possible expected values for each property, due to the different probabilities and prices in the range. Therefore, the average of the possible expected values for each property will be used as the property's expected value, and expected values for the properties will be summed as described above.

The method also allows the user to adjust their preference toward a certain percentage more or less in price and/or time. This adjusts the list and sales price for each property, and the timeframe, by the corresponding percentage, pending that both the list and sales prices remain in the range of the input file. If not, they are increased by the maximum percentage that will allow them to remain within the range of the input file.

The method also allows the user to input predicted expenses for dealing with the properties, to determine the expected net income. The method can also present the average sales price and average probability for the properties, at the expected value level.

FIG. 34 is a block diagram for maximizing revenue for a set of transactions or maximizing revenue per day for a set of transactions. To maximize revenue with the existing mix of properties, the method performs the expected value maximization for each property. If the user wishes to solve using a set price level, the user inputs the list price and initial (minimum) target sales price of each property in their transaction set. The method determines the probability of the price difference (the difference between the list price and target sales price) within the user-specified timeframe (where timeframe can be defined as days on market, days on escrow, or total purchasing time). This is done using FIG. 8B.

Alternately, the user could input an initial (minimum) probability and a list price, and the method determines the sales price for this combination and timeframe, using the functionality described in FIG. 24B, or can find the sales price and time for a probability, using the functionality described in FIG. 10B.

If optimization within a timeframe is not selected, the method simply determines probability for the inputted target price, or price for the inputted target probability, as described in the FIGS. 2B and 4B respectively. In either case, the method multiplies the probability by the target sales price of the property, which provides the expected value for the property.

If the user is working with a buyer, the method will be as described above, but will use the functionalities described in FIGS. 8A, 10A, 24A, 24B, 2A, or 4A. If the user wishes to solve across a range of prices, the method continues determining expected values of all sales prices within the range of sales prices (or probabilities) that are less than or equal to the maximum reasonable value, as defined by the input data set of similar sold properties (the maximum price change in the file).

In any case, each expected value is stored, and the maximum of the expected values is found. The information corresponding to this expected value is stored. The method also allows the user to adjust his preference toward a certain percentage more or less in the inputs, such as price and/or time. This adjusts the initial (minimum) list and sales price for each property, and the timeframe, by the corresponding percentage, pending that both the list and sales prices remain in the range of the input file. If not, they are increased by the maximum percentage that will allow them to remain within the range of the input file. The method can also provide the average sales price or average probability over all of the properties, at the maximized expected value level.

If the user wishes to maximize revenue per day (this can be per day on market, per day on escrow, or per day over the entire course of working with the property), the method is the same as described above, but uses the functionality described in FIG. 5A or 5B4B (if probability is provided) or FIG. 3A or 3B (if price is provided) to determine the price/probability combination that is multiplied to provide expected value for the property. Note that the aforementioned functions also provide the expected time. Dividing expected value by expected time provides expected value per day. Maximization, summation, preferences and averages are provided as for the maximization of expected value, but in this case they are providing information that includes time (such as the average revenue per day).

The above processes and functionalities are available for each property. The maximum expected values for the properties are summed to provide the maximum revenue, and the corresponding sales price and probability are presented for each property, as well as the average sales prices and probability for the set.

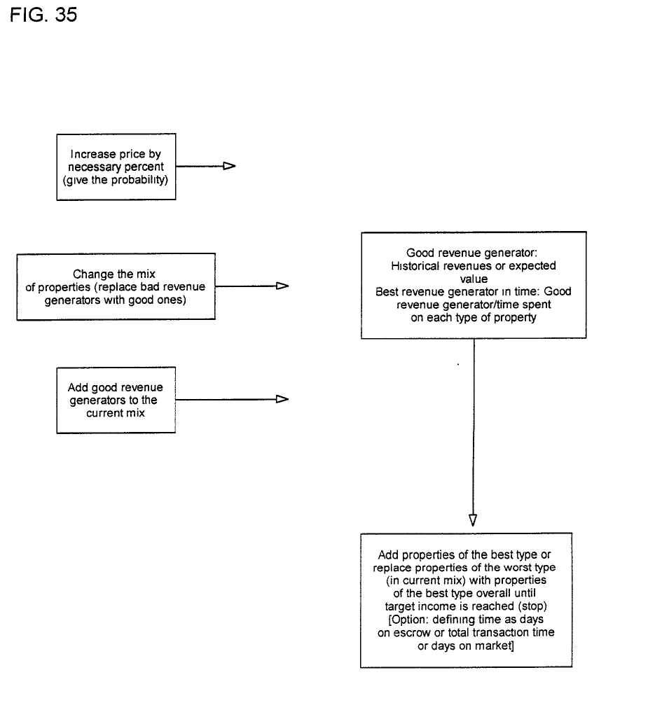

FIG. 35 is a block diagram illustrating the functionality of increasing income to reach a target income. There are three options for increasing revenue to the target revenue. First, prices may be increased by the necessary percentage, thus providing the probability of the new prices in the timeframe, using the functionality described in FIG. 8B or FIG. 2B if no timeframe is selected. Alternately the method or user can change the mix of properties in the set, or can add properties to the set (if the user is willing and able to take on additional properties). The option to use is based on the user's preference. The user will input the available for sale properties that could potentially be added.

If the option is chosen to change the mix of properties or to add properties, it must be determined which type of property to add properties from. The user will input the key information for the properties they sold in the past period of time (where the past period of time is at least a month, and longer if possible). The user can also input a data set containing this information for types of properties that the user would consider working with. The type of property can be defined by the characteristics of the properties, or by one defining characteristic, such as grouping properties by price range.

The method will produce a histogram of the sales prices and timeframe (where timeframe can be defined as days on market, days on escrow, or total purchasing time) for each segment. The method determines the expected value for each of the properties the user is considering, in the period of time (the method can segment this into sub-periods of the period, if the period of time is greater than one month). The expected values are determined by the method described in FIG. 31. The method outputs this information and ranks the types of properties by the expected value. A separate ranking is done for buying and selling.

Alternately, if the user wishes to base the determination of best type on the user's own history, the method will consider the revenues the user has received from each type of property in the past, ranking by the amount of revenue in each time period and overall. To determine the time efficiency of the revenues, the method determines the amount of revenue provided by each type of property in the period of time (the method can segment this into sub-periods of the period, if the period of time is greater than one month) and divides this by the total amount of time spent on that type of property in the period or sub-period. The method provides this information and ranks the segments by the amount of revenues per unit of time in the period and in each sub-period. A separate ranking is done for buying and selling.

The method also allows the user to input predicted expenses for the dealing with the properties, which is subtracted from the revenues for the type of property in the period or sub-period, and this is used in the rankings.

Once the optimum type of property has been determined, the method can add properties from the corresponding best type, which can be the best type overall, or the best type of their current mix, to the user's current set of properties that they are trying to buy or sell. This could potentially add properties from different price ranges for the buying and selling portions until the target revenue is reached. If the user does not wish to add properties, the method may replace properties from the type that is currently the worst of their set, for properties from the best type (the best type overall, or the best type of their current mix), until the target revenue is reached.

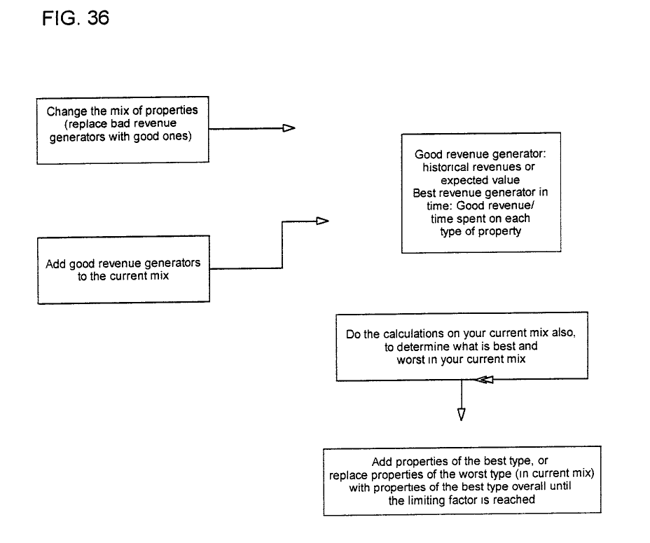

FIG. 36 is a block diagram illustrating the steps for maximizing income by increasing the number of properties in the set or changing the mix. This method follows the same process as FIG. 35, but adds or replaces properties until the limiting factor is reached, thus maximizing income. Also, the option to maximize using only the current set of properties is provided in the functionality in FIG. 34, and thus is not addressed here.

The user may combine functions to maximize overall income. For example, the user can maximize revenue for the current set of properties (using the functionality described in FIG. 34), and then maximize income based on the functionality described in FIG. 35 or 36 (depending on their goals and constraints).

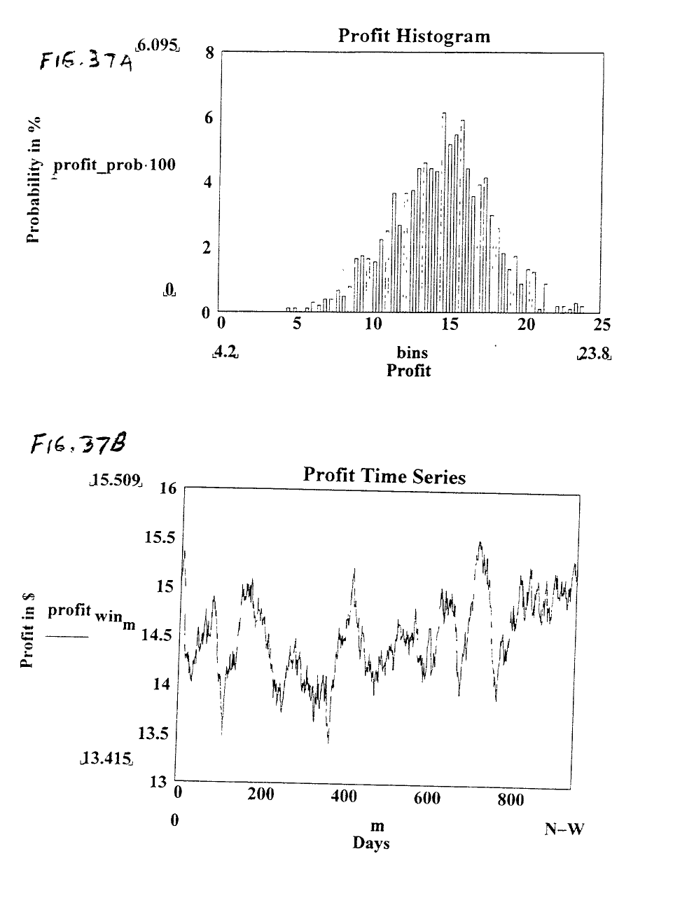

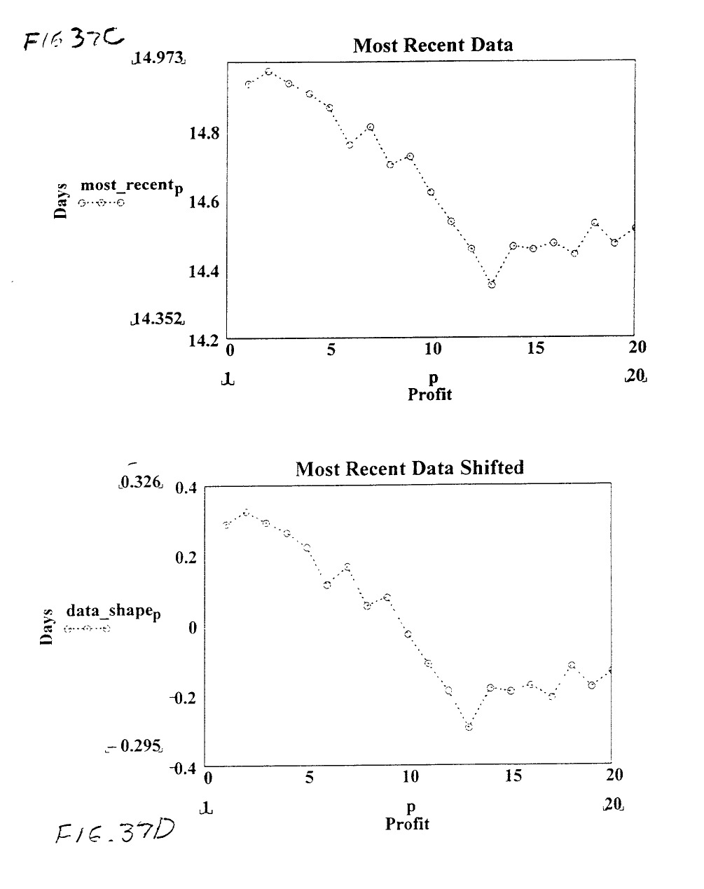

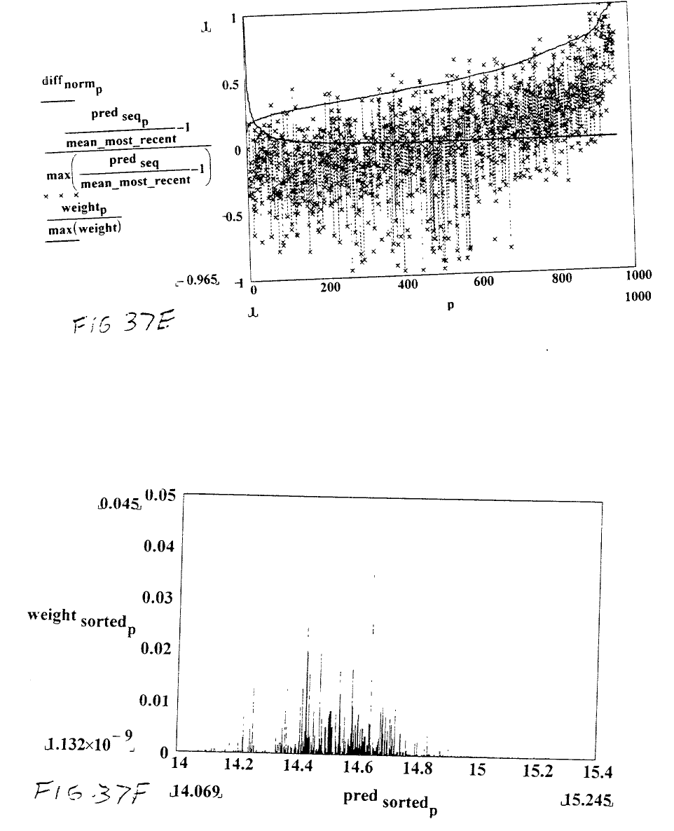

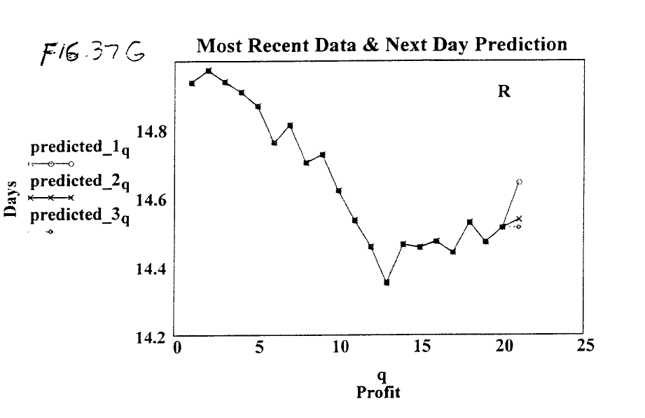

Appendix A includes ancillary calculations on current trends and market prediction. FIG. 37A is a profit histogram utilized for determining current trends and market prediction. FIG. 37B is a profit time series diagram utilized for determining current trends and market prediction. FIG. 37C is a profit diagram of most recent data. FIG. 37D is a diagram of most recent data shifted. FIG. 37E is a graphical representation of computations. FIG. 37F is a histogram of predictions for use in determining current trends and market prediction. FIG. 37G is a diagram and associated calculations for most recent data and next day predictions.

This method determines the current market trend, and predicts the future market trend, over a period of time. The prediction method is based on the theory that market patterns repeat themselves. This method examines past segments of market data with a similar pattern, and uses the value(s) following each historical segment (the value(s) representing the future for said historical segment) to develop predictions for the future for the current pattern of data. The prediction value of the next point in the past patterns is weighted by the degree of matching between the past and current pattern, and also by time, wherein more recent patterns are considered more relevant. The essential idea is that reactions to events follow patterns, even at different market levels.

The method first generates a histogram from a user-inputted data set or data sets. wherein the money and time data used in prediction is taken from the historical data in the file, where the y-axis is the quantity to predict for. The method also plots the average of the data to solve for (which is the current market situation), and plots a time series (where the data to solve for is in the y-axis, and time is on the x-axis). Said time series can be adjusted to remove short-term oscillations; in the preferred embodiment, this will utilize moving averages. In the example in FIGS. 37A-H, the method is solving for professional fees as the y-axis value.

The time series is the essential graph upon which this functionality is based. The method considers a segment of R points, where R is no more than 1/10th of the total amount of points in the data, and attempts to predict future point(s) for the most recent set of R points from the file. (In the example in FIGS. 37A-H, R is 20 and prediction is done for 1 data point into the future). This set to predict for, which is referred as the Predict-For sequence and is shifted to the x-axis, so that the sequence centers around zero. This provides the pattern itself, without a market level. A mean value is found for the R points and is presented to the user as the most current trend.

Next, the method tests all sub-sequences of length R, to determine how well each sub-sequence's pattern matches the pattern in the Predict-For sequence. Matching in the later (more recent) data points of the pattern are given more weight than matches in the earlier points. This is done by an initial weighting of the data points in the pattern by time (giving more recent data points a higher weight), and then using this weight in root-mean-square error (RMS error) calculations for the sequence (and repeating this for all the sequences of length R). The weights must always add up to 1 (they are normalized if necessary).

The equation used for the initial weighting can be done in many ways. Calculation processes include exponential, linear or fractional (1/n) calculations. In the examples of FIGS. 37A-H, exponential weigh in is utilized as the preferred embodiment of the present invention. The method perform the following steps of the sequences of length R:

1. Determine the mean value of the sequence (Mean 1). Determine the mean value again, but this time, include the future point(s), in the mean calculation (Mean 2).

2. Shift the sequence to zero (using Mean 1), which keeps the market pattern, but removes the market level.

3. Determine how well the sequence matches the Predict-For sequence, by finding the RMS error, using the aforementioned weight and the sequence shifted in step 2. The RMS error is calculated using the equation shown in FIG. 34.

4. For the future point(s) for the sequence, remove the market level from the future value by subtracting Mean 2.

5. The RMS error and the shifted future point(s) are stored, and the method moves to the next sequence by shifting the sequence by 1 data point. The shifted future point(s) will be shifted to the market level of the Predict-For sequence.

The above process is repeated for all sequences. The information is stored in sorted order (sorted by RMS error, from least to greatest). Next, a second weighting is done, where the data is weighted by RMS errors (the data with the lower RMS errors are given more weight). Again, the weighting method can be exponential, linear, fractional, or some other method. The weights must add up to 1 (they can be normalized if necessary). The example in FIGS. 37A-H use exponential weighting. The method provides a histogram of predicted values, with the weights for the predictions on the y-axis, and the predictions themselves on the x-axis. Future points are defined by the point estimate, multiplied by the weight. The method finds several potential future points (or future points sets, if the user is predicting more than 1 point into the future), and uses averaging or more preferably, training (described below), to provide a single prediction.

One potential future point is the expected value of the future points in the histogram. This is the scalar product of the data, meaning that each prediction is multiplied by the corresponding weight, providing an expected value, and expected values are summed to provide the overall expected value for the data. Other potential future points are the future point for the sequence that had the lowest RMS error (had the closest match to the pattern), and the future point for the sequence that had the second-lowest RMS error (had the second-closest match to the pattern).

Training is done to determine which of the above future values (or their average) is the best prediction. Training is also done to determine the optimum value of R and the weighting constants used in the second weighting (alpha and beta in the example in FIG. 35), and the best weighting method. The range of constant values to test is constrained in the following ways

1. 0<alpha<1

2. 1/alpha*3 should be about=to R.

3. 1<Beta<100

The prediction error may be biased such that more importance is assigned for correctly predicting recent data by yet another set of “weights.”

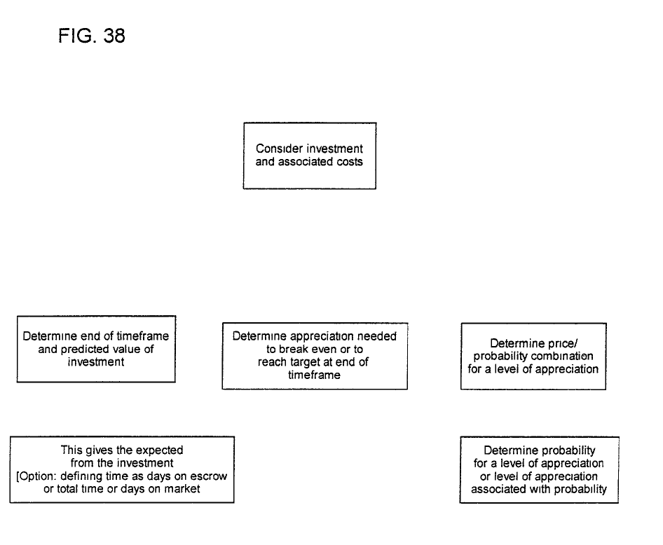

FIG. 38 is a block diagram illustrating the functionality of evaluating a property as an investment. In this functionality, the method sums the amount of the property cost and associated costs (for example, loan interest, tax if applicable, etc.) and determines what amount of price appreciation would be needed to break even or attain a user-specified target, in the user-specified period of time. The method can also present the expected price appreciation over a period of time, using the functionality described in FIGS. 37A-H, which can be used to determine the expected price appreciation (gain, breakeven or loss) from the property as an investment.

The amount of the initial purchase price can be determined by any of the previous functionalities that involve determining a price (where price can be interpreted as a sales price). Specifically, one of the following can be done. First, the method may find the price appreciation associated with a probability, by using any of the previous functionalities (described in previous figures) that include determining a price for a probability (which can include timeframe as a consideration or as an output, if the user so chooses) and can then use predicted price levels from FIG. 35. The method may find the difference between the price and the predicted future price to determine the price appreciation associated with a probability. Alternately, the method may also find the probability associated with a level of price appreciation, by using any of the previous functionalities (described in previous figures) that include determining a probability for a price (which can include timeframe as a consideration or as an output, if the user so chooses), and can then use predicted price levels from FIG. 36. Price appreciation is again defined as the difference between the price and the predicted future price. Finally, if the user wishes to evaluate the property as both an investment and as a replacement for an existing cost, the method may deduct the current cost from the total investment cost.

The user can also input current spending on current costs such as maintenance, service and/or repairs, and the method can determine the expected additional costs for the property, based on statistics on costs for properties of that type, or general statistics on the increase in costs associated with a property purchase.

In any evaluation of the investment, if the user wishes to evaluate a dual-transaction scenario (buying one or more properties, and selling one or more properties), any of the dual transaction functionalities described in the figures may be used, to determine current profit or loss, and this could be added to the predicted investment return to provide the total expected profit (or loss). Predictions of future value and evaluations of costs can be done as previously described. Additionally, all of the above variations can include considerations of time value of money.

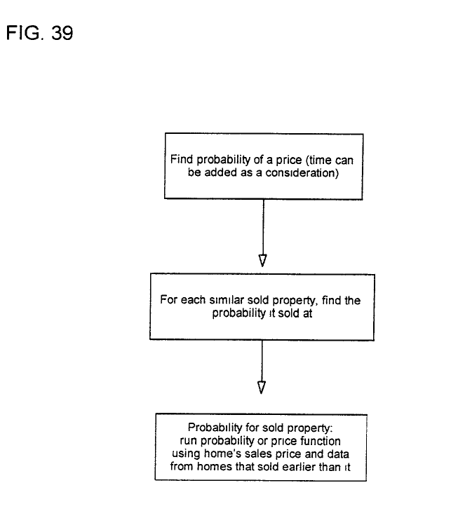

FIG. 39 is a block diagram for evaluating relative probability of a pricing level. In this functionality, the user evaluates the probability of an offer by using the functionalities involving finding a probability (to determine the probability of offer acceptance) and comparing this to the probabilities of acceptance that similar sold properties were sold at. The probability of acceptance at time of sale, for a property that was already sold (the similar sold property), can be found by running the functionalities for finding probability of an offer (using the sales price of the property as the offer) and similar properties that were sold prior to it (the sold property) as the sample data.

This information may be provided, and the average probability at time of sale for the similar sold properties can be presented, as well as the difference between the user's probability and the average. For example, if a seller has a property for sale, similar sold properties and their associated data are found. For each similar sold property, a functionality for finding probability of price (time can be included as an output or as a constraint) may be conducted, utilizing the similar sold property's sales price as the offer price input, and the similar sold property's list price and other data as required by the function. This gives the probability of sale that the similar sold property had, at the winning offer. This same process may be conducted for all similar sold properties and average the probabilities. Next, this information is compared to the user's information, if desired.

A key benefit of this functionality is that it allows the user to determine the level of probability that is most likely to provide a sale, such as in a scenario where a sale is critical. Otherwise, as a buyer, their only option would be to offer a price that is very high. It also gives the seller an additional tool for evaluating offers.

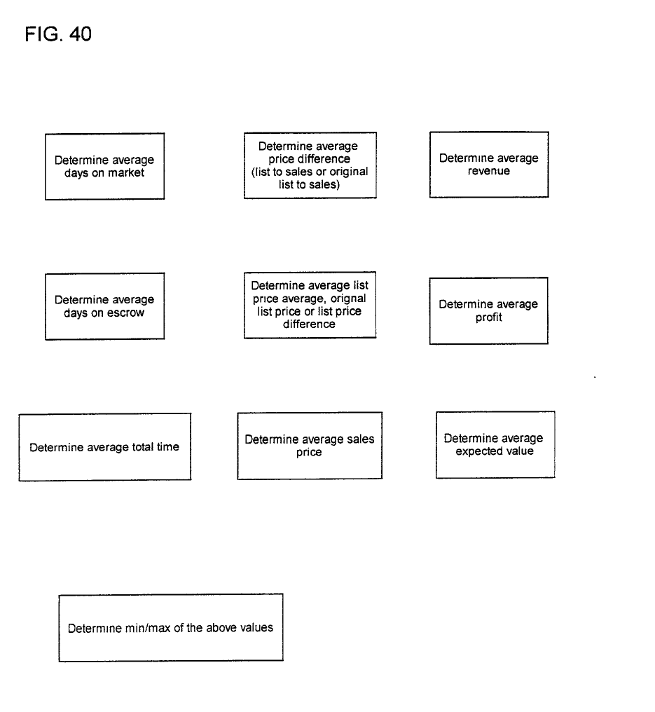

FIG. 40 is a block diagram for averaging values. This method allows the user to select functions for determining the average values of the data. In the preferred embodiment, he average values use means. Average values include the average days on market, average days on escrow, average total time (days on market plus days on escrow), average list-to-sales price difference, average original list-to-sales price difference, average list price difference, and average sales, list and original list prices. The functionality can also provide minimum and maximum values for the items, as well as standard deviation information.

FIG. 41 is a block diagram for linear interpolation of a histogram. This method is used when the exact value of a probability or of an item of key information (profit, price difference or time) is not found in the existing data. Thus this functionality acts to support the other functionalities described in the figures. This method takes in the values of key information that were found at properties with accumulated probabilities just above and just below their target, and interpolates to determine the exact value for the key information. Alternately, if the functionality is meant to determine the probability for key information (where the key information's exact value was not found in the existing data), the functionality interpolates to determine the exact probability.

Essentially, this method accumulates probabilities across the structure, determines the first node that has key information that is larger than the proposed key information (and the previous one, meaning the one that was just barely less than the target). The method uses the accumulated probabilities of these as Y coordinates Y1 and Y2, and uses the key information as X coordinates X1 and X2. It then approximates the line equation in this probability region using the formulas:

M=(Y1−Y2)/(X1−X2) and

Y=mx+b, plugging in m and plugging in one of the known X,Y pairs to solve for b

If the interpolation method is given the target key information, it inputs in the target key information as X, inputs in m and b, and solves for Y, wherein Y is the probability for the key information. Alternately, if the method is given the target probability, it inputs in the probability as Y, inputs in m and b, and solves for X, wherein X is the key information for that probability.

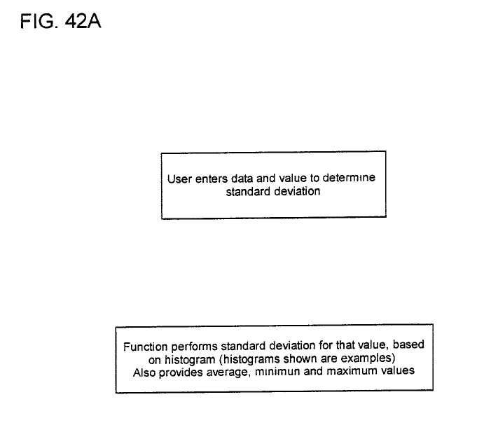

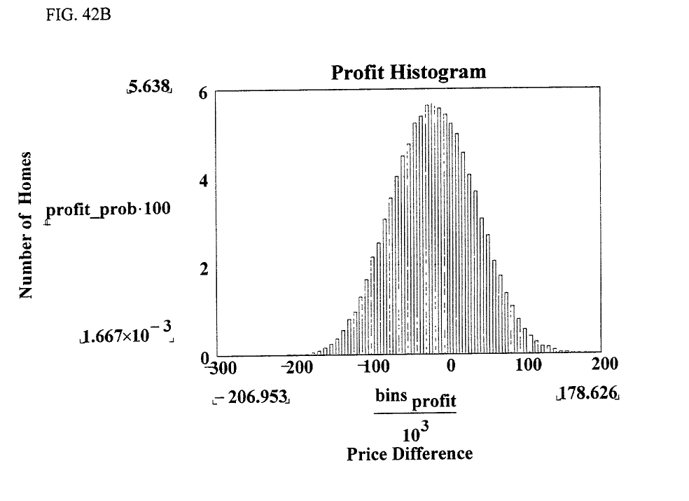

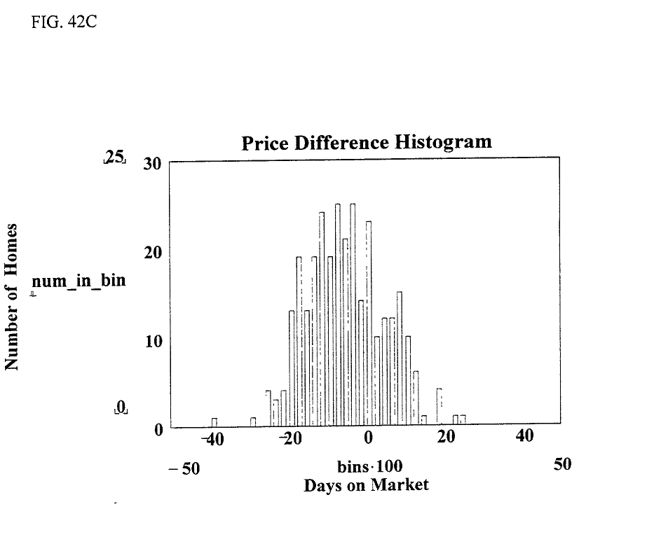

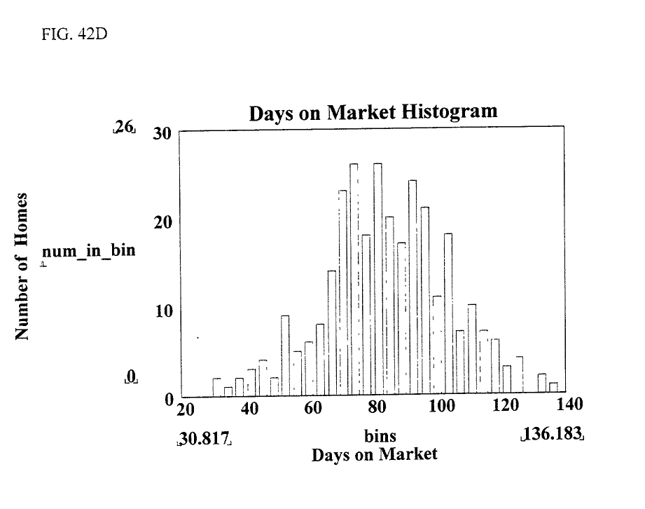

FIG. 42 is a block diagram for determining a standard deviation of FIGS. 42B, 42C, and 42D. FIG. 42B is a profit histogram. FIG. 42C is a price difference histogram. FIG. 42D is a days on market histogram. This functionality can be used along with any of the functions described in the figures. The user enters the data item for which to determine standard deviation for, and the method provides the standard deviation for that value, using the histogram for that value. In FIG. 24, the histograms shown are for Days on Market and Price Difference, but any of the information stored about the properties (including days on escrow, total time, sales price, list price, original list price, etc.) can be used to determine standard deviation(s). The functionality also provides minimum, maximum and mean values for the histogram.

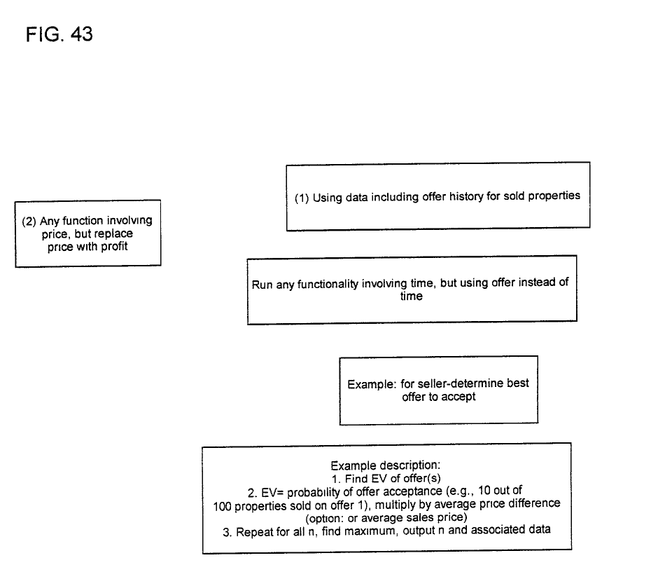

FIG. 43 is a block diagram for variations on existing functionalities utilizing offers and profit. For variation on time-base functionalities used for offers, it is assumed that the offer history is known for each property in the sold properties data set. This can come from the industry database itself, or the library of information created by the user, such as the user's own business database. This functionality essentially runs any of the functionalities involving time, described in this patent, but rather than using days as the time variable, it uses offers.

For example, a seller may wish to determine which offer is best to accept. The method counts the number of properties sold on the first offer, dividing by the number of properties sold overall, and uses this as a probability. The method then finds the average price difference (or average price, as another option) and multiplies the price information by the probability, to determine the expected value of the first offer. This continues for all offers made in the data set. The method finds the offer with the highest expected value, and provides the associated timeframe (for example, the days from when the property was offered from sale) and pricing information. Examples of functions that may be done: determine profit for time, determine profit for probability, determine profit and probability for time, and determine profit and time for probability.

For variations that involve using profit instead of price, the method uses profit rather than price, as the financial variable in functions involving price. The essential algorithm remains unchanged, with any changes being minor, and due to the inclusion of profit (i.e., using profit pairs as nodes, rather than individual properties, etc.)

FIG. 44 illustrates a block diagram for determining self-improvement of the process. The method may run all the functionalities described above as “after the fact,” and to determine the degree of error that the functionalities had on predicting the data, for data points that have already sold. This is accomplished by checking the method's predictions of price, probability, time, expected value, profit, predicted levels, etc. against the actual data that occurred. The degree of error may be used as a confidence level, and the method can then adjust its responses to user inquiries by the respective degree of error for the user's functionality. This provides a step of self-improvement to the entire process, and uses concepts of intelligent agents, learning algorithms or artificial intelligence. The method can also rank the functions by their degree of accuracy (for example, accuracy before adjustment).

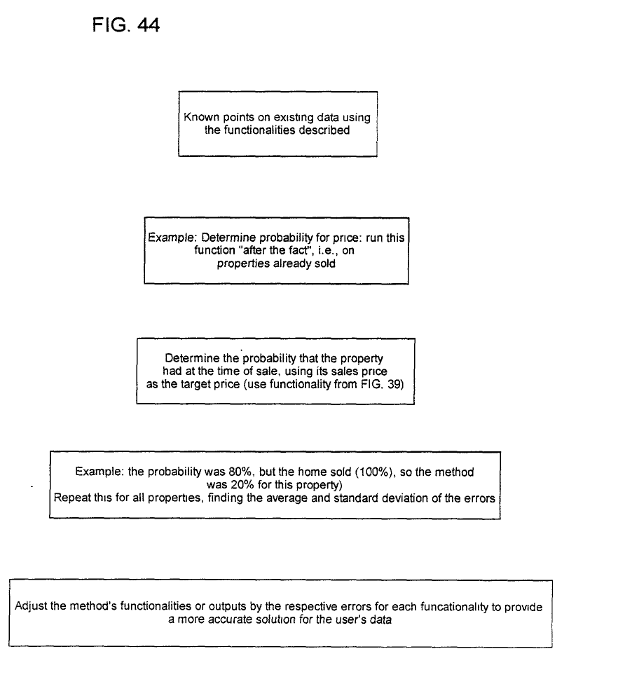

FIG. 45 is a simplified block diagram illustrating the components of a system 200 for optimization of deal-making decisions in the preferred embodiment of the present invention. The system includes a computing system 202 having a database 204, a calculating module 206, and a graphics module 208. In addition, the system includes an input terminal 210 communicating with the computing system 202. The system 200 may also include an independent database 212 communicating with the computing system 202.

The computing system provides statistical and probabilistic analysis of selected data within the calculating module 206. The database 204 stores data for analysis by the calculating module. The graphics module generates graphics of the statistical and probabilistic analysis conducted on the selected data and presented to a user through the input terminal 210. The input terminal may be any device enabling the user to communicate with the computing system. Typically, the input terminal is a conventional desktop computer. The computing system may be an integral component of the input terminal or remotely located and accessed through a communications link (e.g., via Internet).

In addition, the computing system 202 may communicate with the independent database 212 through any type of communications link. The independent database may be any storage device containing data on various types of property, goods, stocks, services, etc. The computing system may select specified data for statistical and probabilistic analysis.

With reference to FIG. 45, the operation of the system 200 will now be explained. The system 200 enables a user to perform a probabilistic and statistical analysis on selected types of data, thus providing relevant information to perform the optimum decision. First, the user must select the type of data and range of field for which the user requires an analysis to be conducted. The user provides his selections through the input terminal 210 to the computing system 202. The selected type of data depends on the type of deal being considered and the scope necessary for a proper analysis. As an example, the user may desire to purchase or sell real estate property from a specific area. The real estate property being considered may include a statistical and probabilistic analysis for a specific general location and/or size of property. Other factors may be used to narrow the scope of the analysis as desired by the user. In addition, based on the type of analysis desired by the user, one or more functionalities of the computing system are automatically determined by the computing system and then performed, as discussed above. Once the selected data is analyzed as discussed above, the results are presented to the user through the input terminal 210. The results may be optionally displayed graphically through the graphics module 208.

FIG. 46 is a flow chart outlining the steps for optimizing deal-making decisions according to the teachings of the present invention. With reference to FIGS. 45 and 46, the steps of the method will now be explained. The method begins with step 300 where the user of the system 200 inputs a selection of desired analysis for a specific property. Property may refer to any good, service, real estate, deal, contract, investment or anything else for which a user may desire to buy, seller analyze. In step 300, the user defines the type of information requiring analysis. Next, in step 302, the computing system receives the inputs from the user and automatically determines the type of historical data necessary to perform the type of requested analysis. The method moves to step 304 where the computing system obtains the determined type of data of step 302. The determined data may be located in the independent database 212 or within the database 204. In step 306, the computing system, through the calculating module 206 stores the retrieved data into the database 204. Next, in step 308, the calculating module performs statistical and probabilistic analysis of the determined data based upon the user's request of step 300. In step 310, the computing system presents the analysis of the determined data to the user through the input terminal 210. The analysis may be presented graphically through the graphical module 208.

In alternate embodiments of the present invention, the disclosed system and methodology may be used for purchase and sale of any market good. Additionally, the disclosed invention may be used for predicting the future market behavior over a period of time. The present invention may be used in such deal-making transactions as venture capital transactions, automobile sales, and contract negotiations.

There are several advantages that the disclosed invention provides over existing systems. For example, a user can determine optimum prices for the amount of risk and time the user is willing to accept. For example, if the user is not satisfied with the probability and/or time results at the specified price, the user may select a suitable probability and/or time, allowing the user to determine the smallest offer price needed to attain a desired probability and time. This allows the user to maximize the efficiency of their time and to optimize their risk, reward, and time duration characteristics according to their desires. Additionally, during purchasing situations, the user can quickly determine which properties are affordable to the user. This determination saves time for both the property buyer and the buyer's agent or broker. It also allows the property seller to avoid using range pricing, while still receiving the wider range of potential buyers that range pricing offers. The user can also determine the expected return (less the costs) for property, and can thus evaluate whether the property makes sense as an investment.

The disclosed invention also offers several advantages to sellers. In selling situations, the user can determine the list price needed to attain the desired final selling price and/or probability, utilizing time as a factor or target. This allows the user to maximize the efficiency of their time and to optimize their risk, reward and speed characteristics according to their needs.

Users may also determine the overall current and future trends of the market, as well as market time and markup averages, giving the user a statistically based indication of the market outlook, and thus, an indicator of the potential risks and rewards of the user's transaction. Buyers or investors may also evaluate the property as an investment, based on predicted future values and current price/probability combinations, providing a powerful statistical basis for decision-making. Users involved in multiple transactions can also predict and control their expected revenues, transaction turnover and risk. Users of the disclosed invention may also optimize their priorities. For example, the user could determine the expected time for a sale. The optimum property(s) and maximized returns may be found through an iterative process for finding the price and probability associated with the target time. The disclosed method may also dynamically correct itself by the degree of error, thus customizing itself to a more accurate prediction of the user's data.

It is thus believed that the operation and construction of the present invention will be apparent from the foregoing description. While the method and system shown and described have been characterized as being preferred, it will be readily apparent that various changes and modifications could be made therein without departing from the scope of the invention as defined in the following claims.

What is claimed is:

1. A system for optimizing decision-making for deal-making transactions through a statistical analysis of historical data, the system comprising:
a computing system for analyzing data; and
an input terminal communicating with said computing system for inputting data on a transaction and selecting a type of analysis on the transaction data;
said computing system having means for receiving historical data relevant to the analysis on the transaction;
whereby said computing system performs a probabilistic analysis on the historical data and presenting the analysis to the user.

2. The system for optimizing decision-making of claim 1 wherein said computing system determines the relevant historical data necessary to conduct the analysis on the transaction from the selection inputted by the user.

3. The system for optimizing decision-making of claim 1 wherein said computing system includes means for presenting the analysis to the user.

4. The system for optimizing decision-making of claim 3 wherein the means for presenting the analysis includes providing the user with a graphical representation of the analysis.

5. The system for optimizing decision-making of claim 1 wherein the analysis is based on a statistical analysis of the relevant historical data.

6. The system for optimizing decision-making of claim 1 wherein said computing system communicates with an independent information source to obtain relevant historical data.

7. The system for optimizing decision-making of claim 1 wherein s aid computing system includes means for storing relevant historical data.

8. The system for optimizing decision-making of claim 1 wherein said inputted data includes probability data on the transaction and said computing system determines price data and time data associated with the transaction.

9. The system for optimizing decision-making of claim 1 wherein said inputted data includes time data on the transaction and said computing system determines price data and probability data associated with the transaction.

10. The system for optimizing decision-making of claim 1 wherein said inputted data includes price data on the transaction and said computing system determines probability data and time data associated with the transaction.

11. The system for optimizing decision-making of claim 1 wherein the computing system determines profit-related data associated with specified transactions.

12. The system for optimizing decision-making of claim 1 wherein the computing system determines optimum selections.

13. A method of optimizing decision-making for deal-making transactions through a probability-based analysis of historical data, said method comprising the steps of:
providing, by a user, a selection of desired analysis to be performed on a specified transaction to a computing system;
determining, by the computing system, relevant historical data necessary for performing the selected analysis on the specified transaction;
obtaining, by the computing system, the relevant historical data;
performing a probability-based analysis on the relevant historical data; and
presenting the analysis to the user, the analysis assisting the user in decision-making on the specified transaction.

14. The method of optimizing decision-making of claim 13 wherein the step of obtaining relevant historical data includes obtaining data from an independent information source separate from the computing system.

15. The method of optimizing decision-making of claim 13 wherein the step of providing a selection of desired analysis includes defining a characteristic of the historical data by the user.

16. The method of optimizing decision-making of claim 13 wherein the computing system determines the relevant data necessary to perform the analysis based on the selection of desired analysis provided by the user.

17. The method of optimizing decision-making of claim 13 wherein the step of determining relevant historical data is based upon current and past market trends.

18. The method of optimizing decision-making of claim 13 wherein the analysis includes relevant historical data on a plurality of available transactions similar to the specified transaction.

19. The method of optimizing decision-making of claim 13 wherein the step of performing a probability-based analysis includes determining expected values of earning for the user from completion of the specified transaction.

20. The method of optimizing decision-making of claim 13 wherein the step of performing an analysis includes determining a relative value on an amenity associated with the specified transaction.

21. The method of optimizing decision-making of claim 13 wherein the analysis is based on speed and revenue of sales during a plurality of transactions taken from the relevant historical data.

22. The method of optimizing decision-making of claim 13 wherein the step of performing an analysis includes determining an impact on a change in list price associated with the specified transaction.

23. The method of optimizing decision-making of claim 13 wherein the step of performing an analysis includes changing at least one variable to compare a characteristic linking the specified transaction with the historical data.

24. The method of optimizing decision-making of claim 13 wherein the step of performing an analysis includes an analysis based on income production.

25. The method of optimizing decision-making of claim 13 wherein the step of performing an analysis is used by the user to determine market trends upon an industry associated with the specified transaction.

26. The method of optimizing decision-making of claim 13 wherein the step of performing an analysis includes utilizing a mathematical method based on time series analysis.

27. The method of optimizing decision-making of claim 13 wherein the step of performing an analysis includes utilizing mathematical self-optimization of a pattern matching algorithm.

28. The method of optimizing decision-making of claim 27 wherein the mathematical self-optimization includes using moving windows of time to determine an ideal constant value for predictive analysis of the specified transaction.

29. The method of optimizing decision-making of claim 13 wherein:
the specified transaction includes a transfer of ownership of a specific property; and
the step of performing an analysis includes evaluating the specific property as an investment by analyzing associated costs and predicted future returns of the specific property.

30. The method of optimizing decision-making of claim 13 wherein the step of performing an analysis includes evaluating a relative probability of the specified transaction by comparing the specified transaction to similar transactions.

31. The method of optimizing decision-making of claim 13 wherein the step of performing an analysis includes evaluating expected values associated with offers associated with the historical data.

32. The method of optimizing decision-making of claim 13 wherein the step of performing an analysis includes evaluating past analysis to determine an error and adjusting the analysis based on the evaluated error.

33. The method of optimizing decision-making of claim 13 wherein the step of performing an analysis includes analyzing the historical data based on histograms.

34. The method of optimizing decision-making of claim 13 wherein the step of performing an analysis includes analyzing the historical data based on probability-density functions.

35. A method of optimizing decision-making for deal-making real estate transactions through a probability-based analysis of historical data, said method comprising the steps of:
providing, by a user, a selection of desired analysis to be performed on a specified real estate transaction to a computing system;
determining, by the computing system, relevant historical data necessary for performing the selected analysis on the specified real estate transaction;
obtaining, by the computing system, the relevant historical data;
performing a probability-based analysis on the relevant historical data; and
presenting the analysis to the user, the analysis assisting the user in decision-making on the specified real estate transaction.
